(19) United States
(12) Patent Application Publication
(10) Pub. No.: US 2022/0315223 A1
(43) Pub. Date: Oct. 6, 2022

(54) MOBILE EMERGENCY COMMUNICATION AND VEHICLE PROPULSION POWER SYSTEM

(71) Applicant: Alakai Technologies Corporation, Stow, MA (US)

(72) Inventor: Brian D. Morrison, Hopkinton, MA (US)

(21) Appl. No.: 17/712,769

(22) Filed: Apr. 4, 2022

Related U.S. Application Data
(60) Provisional application No. 63/170,807, filed on Apr. 5, 2021.

(51) Int. Cl. B64C 39/02; B60L 15/20; G05D 1/10; B60L 50/70; B60L 58/30; B60L 53/20; B64C 29/00; H04L 12/40; H01M 8/0432; H01M 8/04858; H01M 8/04082

(52) U.S. Cl. CPC B64C 39/024; B60L 15/20; G05D 1/102; B60L 50/70; B60L 58/30; B60L 53/20; B64C 29/0016; H04L 12/40; H01M 8/0432; H01M 8/0494; H01M 8/04201; B60L 2200/10; B60L 2210/10; B64C 2201/027; B64C 2201/108; B64C 2201/128; B64C 2201/141; H04L 2012/40215; H04L 2012/4028; H01M 2250/20

(57) ABSTRACT

A mobile emergency communication and vehicle propulsion power system, method, and apparatus for full-scale, clean fuel, electric-powered vehicles having a fuel cell module including a plurality of fuel cells working together to process oxidizers including gaseous oxygen from the atmosphere or local oxygen supply and fuels including gaseous hydrogen from liquid hydrogen, to collect electrons from the plurality of hydrogen fuel cells to supply voltage and current to and control an amount and distribution of electrical voltage or current for use in collecting and amplifying communications signals to function as a cell site repeater and for propulsion systems of the vehicle itself. The system can accordingly be deployed at a location to provide wireless communication functionality in remote areas or areas cut off due to natural disaster.

### CROSS-REFERENCE TO RELATED APPLICATION

This application claims priority to, and the benefit of, co-pending U.S. Provisional Application 63/170,807, filed Apr. 5, 2021, for all subject matter common to both applications. The disclosure of said provisional application is hereby incorporated by reference in its entirety.

### FIELD OF THE INVENTION

The present invention is directed to a mobile emergency communication and vehicle propulsion power system, method, and apparatus for full-scale, clean fuel, electric-powered vehicles having a fuel cell module including a plurality of fuel cells working together to process oxidizers including gaseous oxygen from the atmosphere or local oxygen supply and fuels including gaseous hydrogen from liquid or gaseous hydrogen, to collect electrons from the plurality of hydrogen fuel cells to supply voltage and current to and control an amount and distribution of electrical voltage or current for use in collecting and amplifying communications signals. This allows the vehicle to use onboard electrical power generation capabilities and electronics to function as a cell site or repeater, expanding communication range and volume, and for simultaneous use in propulsion systems of the vehicle itself. It finds particular, although not exclusive, application to on-board fuel cell powered electric (low or no emission) vehicles, including Advanced Air Mobility (AAM) aircraft, where the fuel cell module or other on-board source of power transforms fuel into electricity that is then used to selectively operate multiple electric motors, antennae, and amplifiers. The same power generating systems are used to both propel the vehicle and supply wireless communication signal capability for users such that the vehicle can be piloted to a remote location and simultaneously used as communication signal amplification equipment for external applications immediately upon activation of the appropriate components.

### BACKGROUND

As areas become both more densely populated and more reliant on complex networked electronic devices communicating vast amounts of data, it becomes increasingly difficult to meet electronic communication demands, and significant problems arise in emergencies or in areas where utility electricity is unavailable, or where greater demands on electronic communication signal processing equipment are temporary. Adding additional communication signal processing equipment including antennae, transmitters, receivers, towers, dishes, repeaters, boosters to handle the added load takes time to transport and erect (which may not be available in an emergency) and still then requires significant electrical power generation to activate and operate (which also may not be available in an emergency). Often trailer-mounted generators are towed to areas where grid power has been temporarily disrupted or to supply temporary power for erected portable communications equipment. Trailer-mounted or mobile generators can also be used for emergency or augmented power for communications service installations. Trailer-mounted engine-generators often use a reciprocating engine, powered by combusting fuels including gasoline (petrol), diesel, natural gas and propane (liquid or gas), or hydrogen. This creates redundancy where the vehicle towing the generator requires an additional engine or power generating system to propel the vehicle towing the generator equipment to its intended destination. Erected towers, antennae, or signal boosting equipment quickly become redundant after the spike in demand has passed. This redundancy consumes excess power, emits combustion exhaust inappropriate for certain applications, lowers efficiency, and increases the space required to supply electrical power and reliable means of wireless communication.

Many large cities and metropolitan areas are virtually gridlocked by commuter traffic, with major arteries already at or above capacity, making towing of large generating equipment or erecting of temporary communications masts or equipment increasingly impractical. This issue can be further exasperated in times of emergency. Advanced technologies related to fuel cells can enable more-distributed, decentralized travel and more versatile mobile power generation for communications applications. Additionally, Personal Air Vehicles (PAV), operating in an on-demand, disaggregated, and scalable manner, provide air mobility, power generation, and signal transmission and reception that could extend the effective range and volume of emergency communications delivery, but such systems rely heavily on sophisticated integrated technology. Small Air Mobility Vehicles or aircraft allow for mobile power generation powering communication signal transmission to move efficiently and simply from point-to-any-point, without being restricted by ground transportation congestion or required proximity to electrical utilities. Added benefits include enabling operation of automated self-operated vehicles, and operation of environmentally responsible non-hydrocarbon-powered aircraft for intra-urban applications.

Therefore, a full-scale vehicle and mobile emergency communications signal amplification implementation that finds applications for off-grid and emergency communication applications among others with or without human passengers on board, based on state-of-the-art electric motor and electronics and computer technology with high reliability, safe, simple, and redundant control features, with on-board capability to generate its own electrical power (as opposed to only consuming energy previously stored in electro-chemical batteries), coupled with advanced sensor control techniques is described.

Generating and distributing electrical power aboard a vehicle presents several challenges including inefficient performance and consumption of resources, pollution, greater cost, greater weight or space consumption, restrictions on vehicle configuration, and unwanted vehicle component complexity and redundancy. Such vehicles require state-of-the-art electric motors, electronics, and computer technology with high reliability, safety, simplicity, and redundant control features, with on-board capability to generate electrical power, coupled with advanced sensor and control techniques.

Generating electrical power using a fuel cell is an attractive alternative, but the demands make current fuel cell technology difficult to implement in a practical manner. Generally, a fuel cell is an electrochemical cell of a variety of types that converts the chemical energy of a fuel and an oxidizing agent into electricity directly through chemical reactions (e.g., a pair of redox reactions). Two chemical reactions in a fuel cell occur at the interfaces of three different segments or components: the electrolyte and two electrodes, the negative anode and the positive cathode respectively. A fuel cell consumes the fuel with the net result of the two redox reactions producing electric current which can be used to power electrical devices, normally referred to as the load, as well as creating water or carbon dioxide and heat as the only other products. A fuel, for example hydrogen, is supplied to the anode, and air is supplied to the cathode. A catalyst at the anode causes the fuel to undergo oxidation reactions that generate ions (often positively charged hydrogen ions or protons) and negatively charged electrons, which take different paths to the cathode. The anode catalyst (e.g., platinum powder), breaks down the fuel into electrons and ions, where the electrons travel from the anode to the cathode through an external circuit, creating a flow of electricity across a voltage drop, producing direct current electricity. The ions move from anode to cathode through the electrolyte, which allows ions, often positively charged hydrogen ions (protons), to move between the two sides of the fuel cell. The electrolyte substance, which usually defines the type of fuel cell, and can be made from a number of substances like potassium hydroxide, salt carbonates, and phosphoric acid. The ions or protons migrate through the electrolyte to the cathode. At the cathode, another catalyst causes ions, electrons, and oxygen to react. The cathode catalyst, often nickel, converts ions into waste, forming water as the principal by-product. Thus, for hydrogen fuel, electrons combine with oxygen and the protons to produce only generated electricity, water, and heat.

Fuel cells are versatile and scalable and can provide power for systems as large as power stations or locomotives, and as small as personal electronic devices or hobby drones. The fuel and the electrolyte substance define the type of fuel cell. A fuel cell uses the chemical energy of hydrogen or other fuel to cleanly and efficiently produce electricity. Fuel cells create electricity chemically, rather than by combustion, so they are not subject to certain thermodynamic laws that limit a conventional power plant (e.g., Carnot Limit). Therefore, fuel cells are most often more efficient in extracting energy from a fuel than conventional fuel combustion. Fuel cells generate and manage electrical power through systems that can be modified to perform additional functions including working as a generator to supply electrical power to external devices, boosting system efficiency.

Some fuel cells need pure hydrogen, and other fuel cells tolerate some impurities, but might need higher temperatures to run efficiently. Liquid electrolytes circulate in some cells, which require pumps and additional equipment that decreases the viability of using such cells in dynamic, space-restricted environments. Ion-exchange membrane electrolytes possess enhanced efficiency and durability at a reduced cost. The solid, flexible electrolyte of Proton Exchange Membrane (PEM) fuel cells will not leak or crack, and they operate at a low enough temperature to make them suitable for vehicles. These fuels must be purified, demanding pre-processing equipment such as a “reformer” or electrolyzer to purify the fuel, increasing complexity while decreasing available space. A platinum catalyst is often used on both sides of the membrane, raising costs. Individual fuel cells produce only modest amounts of direct current (DC) electricity and often require many fuel cells assembled into a stack. This poses difficulties in implementations where significant power generation is required but space and particularly weight must be minimized, requiring a more efficient method to implement the relevant chemical reaction, electromagnetic, and thermodynamic principles in a variety of settings and conditions to achieve viable performance.

### SUMMARY

There is a need for an improved lightweight, high power density, fault-tolerant, mobile emergency communication and vehicle propulsion system, method and apparatus for clean fuel, electric-powered vehicles to improve efficiency and effectiveness in generating and using electrical power (voltage and current) to meet dynamic communication needs and needs of a vehicle (including Advanced Air Mobility aircraft) while using available resources instead of consuming or requiring additional resources to function. Further, there is a need to efficiently convert stored liquid hydrogen fuel to gaseous hydrogen fuel for supplying to fuel cells and other power generation components, while limiting the number, mass, and size of systems used within a vehicle. The present invention is directed toward further solutions to address this need, in addition to having other desirable characteristics. Specifically, the present invention relates to a system, method, and apparatus for managing generation and distribution of electrical power to enable mobile wireless communications signaling equipment using fuel cell modules in vehicles (e.g. a full-scale vertical takeoff and landing manned or unmanned aircraft, including Advanced Air Mobility aircraft), containing a system to generate electricity from fuels such as gaseous hydrogen, liquid hydrogen, or other common fuels (including compressed, liquid or gaseous fuels), control power and fuel supply and distribution, and control thermodynamic operating conditions or other vehicle performance. Sensed parameter values about vehicle state are used to detect when recommended vehicle operating parameters are about to be exceeded. By using the feedback from vehicle state measurements to inform control commands, and by voting among redundant autopilot computers, the methods and systems contribute to vehicle operational simplicity, stability, reliability, safety, and low cost. Power is provided by one or more on-board fuel cell modules for generating electrical voltage and current, electronics to monitor and control electrical generation and excess heat or thermal energy production, and motor controllers to control the commanded voltage and current to each motor and to measure its performance (which may include such metrics as resulting RPM, current, torque and temperature among others). Liquid hydrogen may have the pressure of the fluid altered (e.g., expanding the volume) to cause a phase transition to gaseous hydrogen from liquid H₂ and one or more heat exchangers may be employed to warm gaseous hydrogen or to convert it to a gaseous state, which is then supplied to the fuel cells. Excess or waste heat is removed or dissipated from the fuel cell modules, motors, motor controllers, batteries, circuit boards, and other electronics by heat exchangers.

The vehicle may be equipped with redundant Autopilot Computers or control units to accept control inputs by the operator (e.g., using the tablet computer's motion to mimic throttle and joystick commands) and manage commands to the electric motor controllers, advanced avionics, and GPS equipment to provide location, terrain displays, and a simplified, game-like control system. A tablet-computer provides mission planning and vehicle control system capabilities to give the operator the ability to pre-plan a route and have the system move to the destination unmanned via autopilot, or manually control velocity, thrust, pitch, roll, and yaw or other operating parameters, through movement of the tablet computer itself. Control inputs can alternatively be made using a throttle for vertical lift (propeller RPM or torque) control, and a joystick for pitch (nose up/down angle) and bank (angle to left or right) control, or a multi-axis joystick to combine elements of pitch, bank and thrust in one or more control elements, depending on user preferences. The autopilot control unit or motor management computer measures control inputs by the operator or autopilot directions, translates this into commands to the controllers for the individual electric motors according to a known performance table or relevant calculation, then supervises motor reaction to said commands, and monitors vehicle state data (pitch, bank, yaw, pitch rate, bank rate, yaw rate, vertical acceleration, lateral acceleration, longitudinal acceleration, GPS speed, vertical speed, airspeed, and other factors) to ensure operation of the vehicle remains within the desired envelope. Autopilot controls may be used to remotely activate and supply power to antennae or wireless equipment used for receiving and rebroadcasting signals at a vehicle location including incoming cellular communication signals from a distributed set of users.

In accordance with example embodiments of the present invention, a full-scale, electric vertical takeoff and landing (eVTOL) vehicle system having a mobile emergency power communication and vehicle propulsion power system is provided. The eVTOL vehicle system includes a multirotor airframe fuselage; a plurality of propeller assemblies attached to the multirotor airframe fuselage; at least one fuel cell module disposed in the fuselage, the fuel cell module including a plurality of hydrogen fuel cells with at least one electrical circuit configured to collect electrons from each hydrogen fuel cell of the plurality of hydrogen fuel cells and supply voltage and current; a fuel supply subsystem comprising a fuel tank in fluid communication with the at least one fuel cell module; and a power distribution monitoring and control subsystem disposed in the fuselage, monitoring and controlling the distribution of supplied electrical voltage and current from at least one electrical circuit.

The power distribution monitoring and control subsystem includes one or more sensing devices configured to measure operating conditions; a plurality of motor controllers operating the plurality of propeller assemblies; and a cell site subsystem providing wireless communication functionality. The system selectably directs power from the at least one fuel cell module to the plurality of motor controllers to power vehicle propulsion and/or the cell site subsystem.

In accordance with aspects of the present invention, the fuel supply subsystem further comprises one or more auxiliary fuel tanks.

In accordance with aspects of the present invention, the cell site subsystem includes a donor/reception antenna; a rebroadcasting/service antenna; and a bi-directional amplifier.

In accordance with aspects of the present invention, the cell site subsystem includes a cellular repeater in electronic communication with or establishing a datalink with one or more cell sites, cellular towers, or cellular base stations, wherein the cellular repeater, one or more cell sites, cellular towers, or cellular base stations are each governed by a common protocol enabling data to be transferred to and from the cellular repeater and the one or more cell sites, cellular towers, or cellular base stations.

In accordance with aspects of the present invention, the selectable direction of power is controlled via a Controller Area Network (CAN) bus or similar communication network means.

In accordance with aspects of the present invention, the power distribution monitoring and control subsystem further involves the one or more sensing devices configured to measure operating conditions comprising at least a temperature sensor; and the electrical circuit configured to collect electrons from each hydrogen fuel cell of the plurality of hydrogen fuel cells and supply voltage and current to the plurality of motor controllers and vehicle components, wherein electrons returning from the electrical circuit combine with oxygen in compressed air to form oxygen ions, then protons combine with oxygen ions to form H₂O molecules, wherein the plurality of motor controllers are commanded by one or more autopilot control units or computer units comprising a computer processor configured to compute algorithms based on measured operating conditions, and configured to select and control an amount and distribution of electrical voltage or current for each of the plurality of motor controllers and/or the cell site subsystem.

In accordance with aspects of the present invention, the electrical circuit includes an electrical collector disposed within each hydrogen fuel cell and configured to collect electrons from an anode side catalyst layer and supply voltage and current to the electrical circuit powering vehicle components comprising a power distribution monitoring and control subsystem comprising the cell site subsystem, the plurality of motor controllers configured to control the plurality of propeller assemblies in the vehicle, wherein electrons returning from the electrical circuit combine with oxygen in compressed air to form oxygen ions, then protons combine with oxygen ions to form H₂O molecules.

In accordance with aspects of the present invention, the power distribution monitoring and control subsystem includes variable controls for electrical power supply that control varied power output based on user selective activation of the at least one fuel cell module up to an entire 400 kilowatt or greater on-board power generation capacity of a clean fuel aircraft.

In accordance with aspects of the present invention, the system further includes one or more circuit boards; one or more processors; one or more memory; one or more electronic components, electrical connections, electrical wires; and one or more diode or field-effect transistors (FET, IGBT or SiC) providing isolation between an electrical main bus and one or more electrical sources comprising the at least one fuel cell module.

In accordance with aspects of the present invention, the fuel cell module further includes a module housing, a fuel delivery assembly, a recirculation pump, a coolant pump, fuel cell controls, sensors, coolant conduits transporting coolant, connections, a hydrogen inlet, a coolant inlet, an air inlet, a hydrogen outlet, an air outlet, a coolant outlet, and coolant conduits connected to and in fluid communication with the at least one fuel cell module and one or more sensing devices are configured to report temperature and operating conditions or parameters, using a Controller Area Network (CAN) bus, to one or more autopilot control units or computer units and further comprise one or more of pressure gauges, level sensors, vacuum gauges, temperature sensors, and further comprise one or more of the at least one fuel cell modules configured to self-measure or motor controllers configured to self-measure.

In accordance with aspects of the present invention, the vehicle system further includes one or more autopilot control units or computer units comprising at least two redundant autopilot control units or computer units that communicate a voting process over a redundant network to command a plurality of motor controllers, the fuel supply subsystem, at least one fuel cell module, and fluid control units with commands operating valves, pumps, and combinations thereof, altering flows of fuel, air and/or coolant to different locations, thereby controlling the cell site subsystem.

In accordance with aspects of the present invention, the eVTOL is sized, dimensioned, and configured for transporting one or more human occupants and/or a payload, comprising a multirotor airframe fuselage supporting vehicle weight, human occupants and/or payload, attached to and supporting a plurality of motor controllers and propeller assemblies, each comprising a plurality of pairs of rotor blades or propeller blades, and each being electrically connected to and controlled by the plurality of motor controllers and a power distribution monitoring and control subsystem distributing voltage and current from the plurality of hydrogen fuel cells.

In accordance with aspects of the present invention, the vehicle system further includes a mission planning computer comprising software, with wired or wireless (RF) connections to one or more autopilot control units. In some such aspects, the one or more autopilot control units include a computer processor and input/output interfaces including at least one of interface selected from serial RS232, Controller Area Network (CAN), Ethernet, analog voltage inputs, analog voltage outputs, pulse-width-modulated outputs for motor control, an embedded or stand-alone air data computer, an embedded or stand-alone inertial measurement device, and one or more cross-communication channels or networks, and a means of combining data onto a serial line, in such a way that multiple channels of command data pass to the one or more autopilot control units over the serial line, where control information is packaged in a plurality of frames that repeat at a periodic or aperiodic rate. In certain aspects, the vehicle system further includes a simplified computer and display with an arrangement of standard avionics used to monitor and display operating conditions including of the cell site subsystem, control panels, gauges, and sensor output for the eVTOL.

In accordance with aspects of the present invention, the vehicle system further includes a DC-DC converter or starter/alternator configured to down-shift at least a portion of a primary voltage of a multirotor aircraft system to a standard voltage comprising one or more of the group consisting of 12V, 24V, 28V, or other standard voltage for avionics, cell site subsystem, radiator fan motors, compressor motors, water pump motors and non-propulsion purposes, with a battery of corresponding voltage to provide local current storage.

In accordance with example embodiments of the present invention, a method of operating an integrated mobile emergency communication and vehicle propulsion power system disposed in a full-scale, eVTOL vehicle is provided. The method includes providing an eVTOL vehicle having an integrated mobile emergency communication and vehicle propulsion power system; at least one fuel cell module of the comprising a plurality of hydrogen fuel cells with at least one electrical circuit collecting electrons from each hydrogen fuel cell of the plurality of hydrogen fuel cells and supplying voltage and current; a fuel supply subsystem of the integrated mobile emergency communication and vehicle propulsion power system fueling the at least one fuel cell module; and a power distribution monitoring and control subsystem of the integrated mobile emergency communication and vehicle propulsion power system distributing supplied voltage and current from at least one electrical circuit including one or more sensing devices measuring operating conditions; a cell site subsystem providing wireless communication functionality; and selectably directing power from the at least one fuel modules to power vehicle propulsion and/or to the cell site subsystem.

In accordance with aspects of the present invention, the method further includes measuring and reporting operating conditions or parameters, using one or more sensing devices, and a Controller Area Network (CAN) bus to inform one or more autopilot control units or computer units, based on data from one or more of pressure gauges, level sensors, vacuum gauges, temperature sensors, the at least one fuel cell modules configured to self-measure or motor controllers configured to self-measure. In certain aspects, the method repeats measuring, using one or more digital feedback measurements communicated by the cell site subsystem via the Controller Area Network (CAN) bus, operating conditions in the cell site subsystem, and then performs comparing, computing, selecting and controlling, and executing steps using data for the one or more fuel cell modules to iteratively manage electric voltage and current production and supply by the one or more fuel cell modules and operating conditions in the cell site subsystem. In some aspects, the method repeats measuring, using one or more temperature sensing devices or thermal energy sensing devices, operating conditions in a multirotor aircraft, and then performs comparing, computing, selecting and controlling, and executing steps using data for the one or more fuel cell modules to iteratively manage electric voltage and current or torque production and supply by the one or more fuel cell modules and operating conditions in the eVTOL vehicle.

In accordance with aspects of the present invention, the vehicle further includes one or more autopilot control units or computer units comprising at least two redundant autopilot control units that communicate a voting process over a redundant network to command, using one or more autopilot control units that operate control algorithms generating commands, a plurality of motor controllers, the fuel supply subsystem, the one or more fuel cell modules, and fluid control units with commands operating valves, pumps, and combinations thereof, altering flows of fuel, air and/or coolant to different locations, managing and maintaining vehicle stability and monitoring feedback.

In accordance with example embodiments, a method of providing emergency communication is provided. The method includes providing an eVTOL vehicle having an emergency communication system as disclosed herein; deploying the eVTOL vehicle having the emergency communications system to a location requiring emergency communication; and activating the cell site subsystem to provide wireless communication.

In accordance with aspects of the present invention, the eVTOL vehicle having been deployed to the location loiters in air at the location for an extended period of time.

In accordance with aspects of the present invention, the fuel supply subsystem of the eVTOL vehicle further comprises one or more auxiliary tanks to further increase the available loitering time.

### BRIEF DESCRIPTION OF THE DRAWINGS

The invention description below refers to the accompanying drawings, of which:

FIG. 1 depicts two views demonstrating the position and configuration of components of the mobile emergency communication and vehicle propulsion power system;

FIGS. 2A, 2B, 2C and 2D depict an example system block diagram for practicing the present invention, including electrical and systems connectivity and logic controlling the integrated system;

FIG. 3 depicts electrical and systems connectivity of various fuel cell, fuel supply, power generation, and motor control components of a system of the invention;

FIG. 4 depicts a cell site system employed in the mobile emergency communication and vehicle propulsion power system;

FIG. 5 depicts example configurations of fuel cells within the vehicle;

FIG. 6 depicts example subcomponents of fuel cells in at least one fuel cell module within the vehicle;

FIG. 7 depicts example internal subcomponents of fuel cells within the vehicle;

FIG. 8 depicts an example of control panel, gauge, and sensor output for the vehicle;

FIG. 9 depicts example profile diagrams of the fuel supply subsystems, power generation subsystems, amplification subsystems, and components within the vehicle;

FIG. 10 depicts multiple views of a multirotor aircraft with six rotors cantilevered from the frame of the multirotor aircraft in accordance with an embodiment of the present invention, demonstrating the position and compartments housing the fuel supply and power generation subsystems;

FIG. 11 depicts example subcomponents of fuel tanks and fuel supply subsystem within the multirotor aircraft;

FIG. 12 depicts an example diagram of the fuel tank, fuel cell, radiator, heat exchanger and cooling components;

FIG. 13 depicts a flow chart that illustrates the present invention in accordance with one example embodiment; and

FIG. 14 depicts a flow chart that illustrates the method of providing emergency communication in accordance with one example embodiment of the present invention.

### DETAILED DESCRIPTION

To provide an overall understanding, certain illustrative embodiments will now be described; however, it will be understood by one of skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods.

An illustrative embodiment of the present invention relates to a lightweight, high power density, fault-tolerant fuel cell integrated mobile emergency communication and vehicle propulsion system, method and apparatus for clean fuel, electric-powered vehicles, including AAM aircraft. The integrated system also comprises a fuel supply subsystem comprising a fuel tank in fluid communication with one or more fuel cell modules and configured to store and transport a fuel such as liquid hydrogen, gaseous hydrogen, or a similar fluid, one or more vents, one or more outlets, and one or more exhaust ports, one or more temperature sensing devices or thermal energy sensing devices, configured to measure thermodynamic operating conditions, and an autopilot control unit comprising a computer processor. The combined system can transport itself to desired locations powered by the fuel cells, and upon establishing position at a desired geographic location, can selectably direct power from the fuel cells to the cell site subsystem to provide wireless communication functionality.

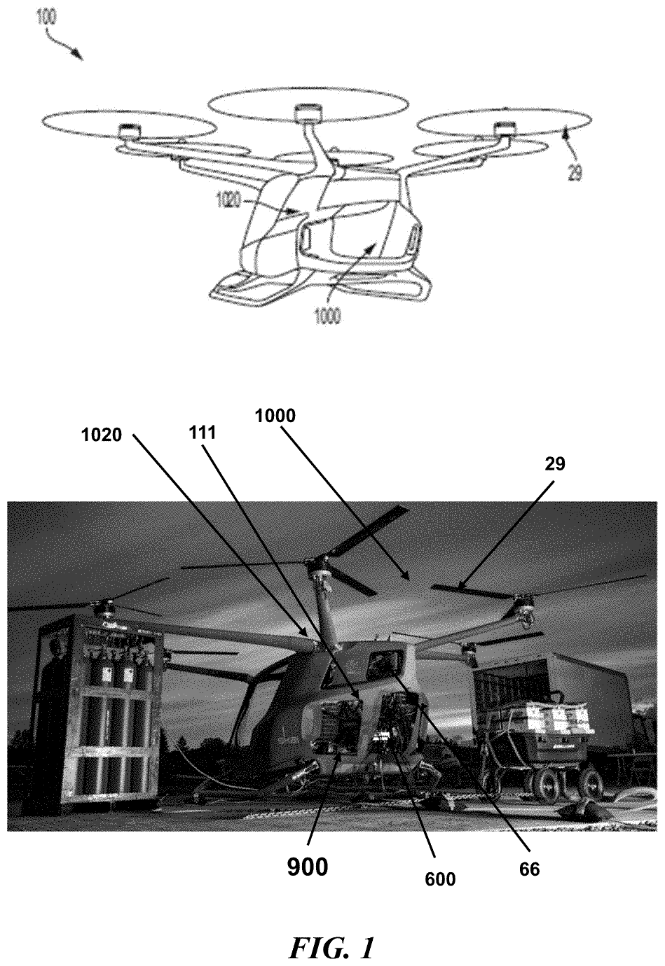

FIGS. 1-14, wherein like parts are designated by like reference numerals throughout, illustrate an example embodiment or embodiments of a lightweight, high power density, fault-tolerant multi-function combined emergency communications and propulsion system, method and apparatus for a clean fuel, electric-powered vehicle, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts diagrams demonstrating example positions of fuel supply subsystems 900 and power generation subsystems 600 within the vehicle 1000 (here an example multirotor aircraft). The vehicle architecture comprises multi-use power generation subsystems 600 that supply electrical power for vehicle propulsion, internal device and sensor operation, and a cell site subsystem 111 to transform the vehicle into a mobile wireless signal repeater for user devices interfaced with the system. The vehicle power generation subsystems 600 are in electronic communication with the cell site subsystem 111 which in certain embodiments comprises at least a donor/reception antenna, a rebroadcasting/service antenna, and a bi-directional amplifier a signal amplifier together with appropriate software and logic to function using existing vehicle control infrastructure (where existing vehicle electronic components may be reprogrammed or repurposed to transform into communication amplification components for specific applications). The cell site subsystem 111 components may comprise an array of external antennae or components of existing onboard communications equipment. In example embodiments, the antennae may be omnidirectional antennae and may be removably or permanently connected to the top, sides, bottom, front or back of the vehicle, or within specified components onboard the vehicle, where these elements are in electronic communication with vehicle mission control computers, autopilot control units and are part of electrical power supply circuits that are selectively activated and connected to the vehicle power generation subsystems comprising one or more fuel cell modules to provide electrical power (voltage and current) to the appropriate required parameters. These parameters may vary according to voltage and current rating, shape, size, and connector type. Different standard communication components may be employed based on particular jurisdiction regulation, as understood by one of skill in the art. Various insulating, disconnecting (circuit breaking, GFCI), attenuating and grounding components are included to prevent harm to users and to reduce signal noise or interference by isolating incoming and outgoing signal processing (via interference cancellation equipment). To reduce the risk of electric shock, subsystems and components may have safety features including insulated sleeves, recessed sockets, and/or automatic shutoffs. The array of antennae and wireless communication equipment of the cell site subsystem 111 can be activated by an onboard control tablet or activation switch in electronic communication with the at least one electrical circuit of the at least one fuel cell module and controlling distribution of electrical power between vehicle propulsion and/or the cell site subsystem 111. Additional activation means known in the art, including remote or autonomous activation through vehicle or external processors and wireless signaling may be incorporated into the system. Cell site subsystem 111 component indicators or power indicators may also be included, comprising e.g., one or more light-emitting diodes (LEDs) that are displayed or illuminated when power is being supplied to the cell site subsystem 111 while it functions as e.g., a cellular repeater (bi-directional amplifier used to improve cell phone reception). External feedback mechanisms including visual displays, exterior or surface lights, and display screens can be programmed by the system to convey information to internal or external users that may include indication of operational repeater services or instructions for how to access and use the amplification functions of the repeater (e.g., in an implementation for a mobile hotspot situated within an emergency communication area). The cell site subsystem 111 elements may further comprise surge protectors, spike suppressors, lightning arrestor subsystems, or other safety components known in the art. The logic controlling the onboard power supply for propulsion and electronics controls the function of the cell site subsystem 111 as well in a unitary, integrated, and consolidated system to improve efficiency, convenience, and responsiveness, while minimizing payload.

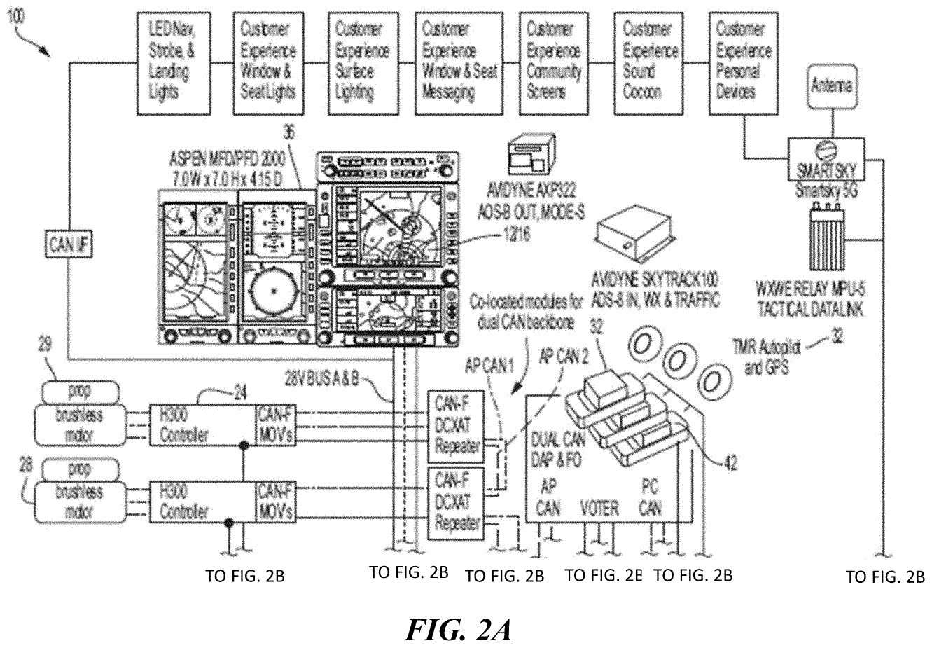

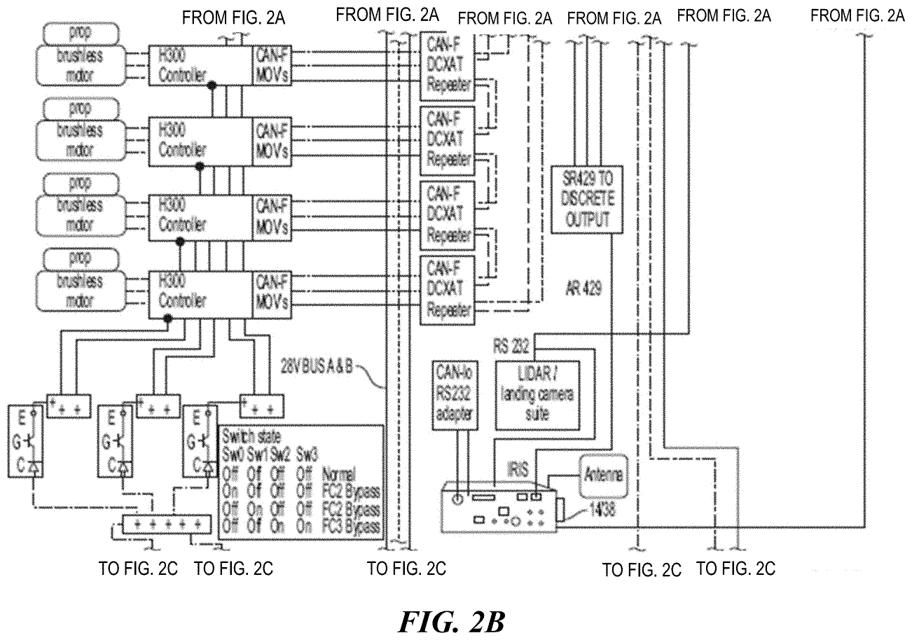

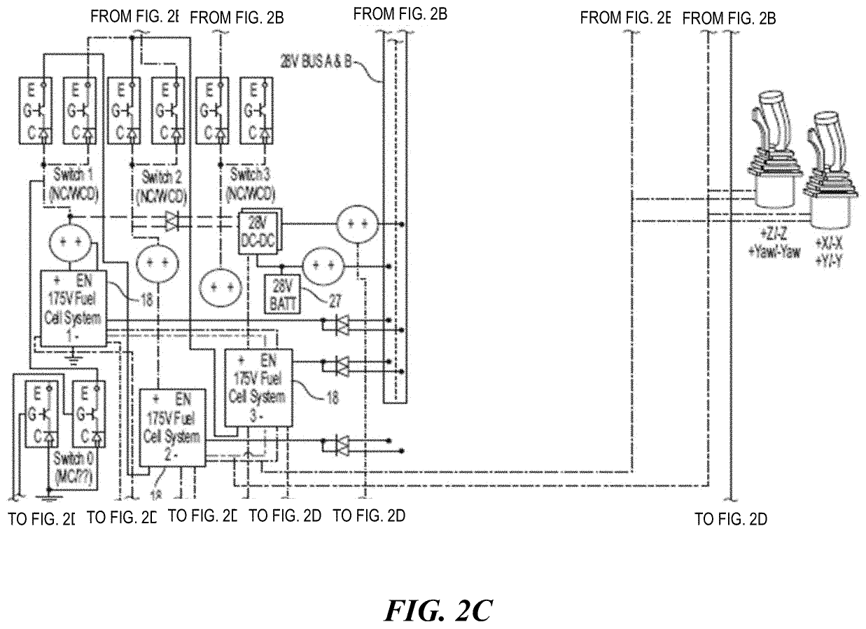

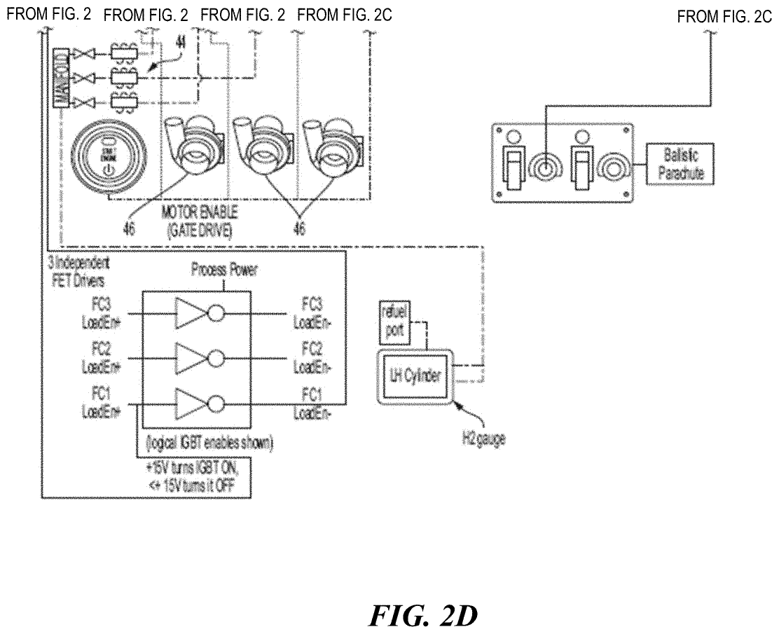

FIGS. 2A, 2B, 2C and FIG. 2D depict in block diagram form one type of system 100 that may be employed to carry out the present invention. Here, managing power generation for a vehicle includes on-board equipment such as a primary flight displays 12, an Automatic Dependent Surveillance-B (ADSB) or Remote ID transmitter/receiver 14, a global positioning system (GPS) receiver typically embedded within 12, a fuel gauge 16, an air data computer to calculate airspeed and vertical speed 38, mission control tablet computers 36 and mission planning software 34, and redundant flight computers (also referred to as autopilot computers 32 or autopilot control units), all of which monitor either the operation and position of the vehicle 1000 or monitor and control the hydrogen-powered fuel cell based power generation subsystem 600 generating electricity and fuel supply subsystems 900 and provide display presentations that represent various aspects of those systems' operation and the vehicle's 1000 state data, such as altitude, attitude, ground speed, position, local terrain, path, weather data, remaining fuel, motor voltage and current status, intended destination, and other information necessary to successful and safe operation. The fuel cell-based power generation subsystem 600 combines stored hydrogen with compressed air to generate electricity with a byproduct of only water and heat, thereby forming a fuel cell module 18 that can also include pumps of various types and cooling system 44 and a turbocharger or supercharger 46 to optimize the efficiency and/or performance of the fuel cell module 18. As would be appreciated by one skilled in the art, the fuel cells may also be augmented by a battery (or supercapacitor, combination thereof or other energy storage system as understood by one of ordinary skill in the art) subsystem, consisting of high-voltage battery array, battery monitoring and charger subsystem or similar arrangements. This disclosure is meant to address both power generation systems and hybrid stored-energy battery systems incorporating both means of energy storage.

FIGS. 2A, 2B, 2C and FIG. 2D depict system diagrams of an example embodiment, including electrical and systems connectivity for various control interface components of a system 100 of the invention, including logic controlling the generation, distribution, adjustment and monitoring of electrical power (voltage and current). Vehicle state (pitch, bank, roll, yaw, airspeed, vertical speed and altitude) are commanded a) by the operator using physical motions and commands made using one of: mission control tablet computers 36, sidearm controllers, commands transmitted across secure datalinks or pre-planned mission routes selected and pre-programmed using the mission control tablet computers 36 and mission-planning software 34 in support of autonomous mode; or b) in autonomous or UAV mode using pre-planned mission routes selected and pre-programmed using the mission control tablet computers 36 and mission-planning software 34 and uploaded to the onboard autopilot system prior to launch. The mission control tablet computer 36 may transmit the designated route or position command set to autopilot computers 32 and voter 42 over a serial, radio-control, or similar datalink, and if so, the autopilot may then utilize that designated route or position command set (e.g., a set of altitudes and positions to form a route that is to be traveled from origin to destination). Depending on the equipment and protocols involved in the example embodiment, a sequence of commands may be sent using a repeating series of servo control pulses carrying the designated command information, represented by pulse-widths varying between 1.0 to 2.0 milliseconds contained within a ‘frame’ of, for example, 10 to 30 milliseconds). Multiple ‘channels’ of command data may be included within each ‘frame’, with the only caveat being that each maximum pulse width must have a period of no output (typically zero volts or logic zero) before the next channel's pulse can begin. In this way, multiple channels of command information are multiplexed onto a single serial pulse stream within each frame. The parameters for each pulse within the frame are that it has a minimum pulse width, a maximum pulse width, and a periodic repetition rate. Note that the motor's RPM is not determined by the duty cycle or repetition rate of the signal, but by the duration of the designated pulse. The autopilot might expect to see a pulse every 20 ms, although this can be shorter or longer, depending upon system 100 requirements. The width of each channel's pulse within the frame will determine how fast the corresponding motor turns. For example, anything less than a 1.2 ms pulse may be pre-programmed as ‘Motor OFF’ or 0 RPM (where a motor in the off state can be spun freely by a person, whereas a motor commanded to be at 0 RPM will be “locked” in that position), and pulse widths ranging from 1.2 ms up to 2.0 ms will proportionately command the motor from 20% RPM to 100% RPM. In another embodiment, motor commands may be transmitted digitally from the autopilot to the motor controllers 24 and status and/or feedback may be returned from the motor controllers 24 to the autopilot using a digital databus such as Ethernet or CAN (Controller Area Network), one of many available digital databusses capable of being applied, using RF or wire or fiber optics as the transmission medium. A modem (modulator-demodulator) may be implicitly present within the datalink device pair, so that the user sends Ethernet or CAN commands, the modem transforms said data into a format suitable for reliable transmission and reception across one or more channels, and the mating modem transforms that format back into the original Ethernet or CAN commands at the receiving node, for use within the autopilot system. As understood by a person of ordinary skill in the art, many possible embodiments are available to implement wireless data links between a tablet or ground pilot station and the vehicle, just as many possible embodiments are available to transmit and receive data and commands among the autopilot, the motor controllers 24, and the fuel cells and support devices that form the on-board power generation and motor controlling system.

The receiver at each autopilot then uses software algorithms to translate the received channel pulses correlating to channel commands from the tablet computer or alternate control means (in this example the set of pulse-widths representing the control inputs such as pitch, bank and yaw, and rpm) into the necessary outputs to control each of the multiple (in this example six) motor controllers 24, motors, and e.g., rotors 29 or propellers to achieve the commanded vehicle motions. Commands may be transmitted by direct wire, or over a secure RF (wireless) signal between transmitter and receiver, and may use an RC format, or may use direct digital data in Ethernet, CAN, or another suitable protocol. The autopilot is also responsible for measuring other vehicle state information, such as pitch, bank angle, yaw, accelerations, and for maintaining vehicle stability using its own internal sensors and available data.

The command interface between the autopilots and the multiple motor controllers 24 will vary from one equipment set to another, and might entail such signal options to each motor controller 24 as a variable DC voltage, a variable resistance, a CAN, Ethernet or other serial network command, an RS-232 or other serial data command, or a PWM (pulse-width modulated) serial pulse stream, or other interface standard obvious to one skilled in the art. Control algorithms operating within the autopilot computer 32 perform the necessary state analysis, comparisons, and generate resultant commands to the individual motor controllers 24 and monitor the resulting vehicle state and stability. A voting means 42 (e.g., triple-redundant voting among inputs to detect a possible failure) decides which two of three autopilot computers 32 are in agreement, and automatically performs the voting operation to connect the proper autopilot computer 32 outputs to the corresponding motor controllers 24 or amplifying subsystem 111. Other levels of redundancy are also possible subject to meeting safety of flight requirements and regulations, and are obvious to one skilled in the art.

In a preferred control embodiment, the commanded vehicle motion and motor rpm commands could also be embodied by a pair of joysticks and a throttle, a pair of traditional sidearm controllers including a throttle, a steering wheel or control yoke capable of left-right and fore-aft motion, where the joysticks/sidearm controllers/wheels/yokes provide readings (which could be potentiometers, hall-effect sensors, or rotary-variable differential transformers (RVDT)) indicative of commanded motions which may then be translated into the appropriate message format and transmitted to the autopilot computers 32 by network commands or signals, and thereby used to control the multiple motor controllers 24, motors and rotors 29. The autopilot may also be capable of generating ‘go left’, ‘go right’ ‘go forward’ ‘go backward’, ‘yaw left’ or ‘yaw right’ commands, all while the autopilot is simultaneously maintaining the vehicle in a stable, level or approximately level state.

Motors of the multiple motors and rotors 29 in the preferred embodiment are brushless synchronous three-phase AC or DC motors, capable of operating as an aircraft motor, and that are either air-cooled or liquid-cooled (by coolants including water, anti-freeze, oil, or other coolants understood by one of ordinary skill in the art) or both. Throughout all of the system 100 operation, controlling, and operating the vehicle is performed with the necessary safety, reliability, performance, and redundancy measures required to protect human life to e.g., accepted flight-worthiness standards.

Electrical energy to operate the vehicle is derived from the fuel cell modules 18, which provide voltage and current to the motor controllers 24 through optional high-current diodes or Field Effect Transistors (FETs) 20 and circuit breakers 902. High current contactors 904 or similar devices are engaged and disengaged under control of the vehicle key switch 40, similar to a car's ignition switch, which applies voltage to the starter/generator 26 to start the fuel cell modules 18 and produce electrical power. For example, the high current contactors 904 may be essentially large vacuum relays that are controlled by the vehicle key switch 40 and enable the current to flow to the starter/generator 26. In accordance with an example embodiment of the present invention, the starter/generator 26 also supplies power to the avionic systems of the vehicle 1000 (e.g., aircraft). Once stable power is available, the motor controllers 24 each individually manage the necessary voltage and current to achieve the desired thrust by controlling the motor in either RPM mode or torque mode, to enable thrust to be produced by each motor and propeller/rotor combination 28. The number of motor controllers 24 and motor/rotor combinations 28 per vehicle may be as few as 4, and as many as 16 or more, depending upon vehicle architecture, desired payload (weight), fuel capacity, electric motor size, weight, and power, and vehicle structure. Advantageously, fuel cells and smaller motors with lower current demands can produce the necessary voltage and current at a total weight for a functional aviation vehicle while achieving adequate flight durations and allows the failure of one or more motors or motor controllers 24 to be compensated for by the autopilot to allow continued safe flight and landing in the event of said failure.

The fuel cells 18 are supplied by on-board or auxiliary fuel storage. The ability to refuel the vehicle 1000 (e.g., multirotor aircraft) fuel tanks 22 at the origin, at the destination, or at roadside refueling stations is fundamental to the vehicle's utility and remote or emergency communication applications. The ability to refuel the fuel tanks 22 to replace the energy source for the motors reduces the downtime required by conventional all electric vehicles (e.g., battery-operated vehicles), which must be recharged from an external electricity source, which may be a time-consuming process. Fuel cells and fuel cell modules 18 can be powered by hydrogen. Accordingly, the fuel cell modules 18 can create electricity from fuel to provide power to the motors on the vehicle 1000 or the cell site subsystem 111. The use of fuel cell modules 18 are more weight efficient than batteries and provide a greater energy density than existing Li-ion batteries, thereby reducing the work required by the motors to produce lift. Additionally, the use of hydrogen fuel cells reduces the amount of work required by the motors due to the reduced weight as the fuel 30 is consumed.

Due to the nature of the all-electric vehicle, it is also possible to carry an onboard high-voltage battery and recharging subsystem in addition to fuel cell modules 18, with an external receptacle to facilitate recharging the onboard batteries.

Power to operate the vehicle's electronic systems or avionics 12, 14, 16, 32, 34, 36, 38 and support lighting is provided by either a) a low-voltage starter-generator 26 powered by the fuel cell modules 18 and providing power to avionics battery 27, orb) a DC-to-DC Converter providing energy to Avionics Battery 27. If the DC-to-DC Converter is used, it draws power from high-voltage produced by the fuel cell modules 18 and down-converts the higher voltage, typically 300V DC to 600 VDC in this embodiment, to either 12V, 24V or 28V or other voltage standards, any of which are voltages typically used in small aircraft systems. Navigation, strobe, and landing lights draw power from 26 and 27 and provide necessary illumination for safety and operations at night under US and foreign regulations. Suitable circuit breaker 902 and switch means are provided to control ancillary lighting devices as part of the overall system 100. These devices are commonly implemented as Light Emitting Diode (LED) lights, and may be controlled either directly by one or more switches, or by a databus-controlled switch in response to a CAN or other digital databus command. These devices can also illuminate the amplifying subsystem 111 components for ease of use in night or low light conditions. If a CAN or databus command system is employed as shown in FIG. 2B, then multiple ‘user experience’ or UX devices may also be employed, to provide enhanced user experience with such things as cabin lighting, seat lighting, window lighting, window messaging, sound cancellation or sound cocoon control, exterior surface lighting, exterior lighting, exterior surface messaging or advertising, seat messaging, cabin-wide passenger instruction or in-flight messaging, passenger weight sensing, personal device (e.g. iPhone, tablet, iPad, (or Android or other device equivalents or similar personal digital devices) connectivity and charging, and other integrated features as may be added within the cabin or vehicle.

In one example embodiment, pairs of motors for the multiple motors and rotors 29 are commanded to operate at different RPM or torque settings (determined by whether the autopilot is controlling the motors in RPM or torque mode) to produce slightly differing amounts of thrust under autopilot control, thus imparting a pitch moment, or a bank moment, or a yaw moment, or a change in altitude, or a lateral movement, or a longitudinal movement, or simultaneously any combination of the above to the vehicle 1000, using position feedback from the autopilot's 6-axis built-in or remote inertial sensors to maintain stable flight attitude. Sensor data is read by each autopilot to assess its physical motion and rate of motion, which is then compared to commanded motion in all three dimensions to assess what new motion commands are required.

Of course, not all vehicles will employ the same mix of electronics, instrumentation or controllers, or motors, and some vehicles will include equipment different from this mix or in addition to this mix. Not shown for example are radios as may be desirable for communications or other small ancillary electronics customary in vehicles. Whatever the mix is, though, some set of equipment accepts input commands from an operator, translates those input commands into differing thrust amounts from the pairs of counter-rotating motors and rotors 29, and thus produces pitch, bank, yaw, and/or vertical motion of the vehicle 1000, or lateral and longitudinal as well as and vertical and yaw motion of the vehicle 1000, using differing commands to produce differential thrust from the electric motors operating rotors 29 in an assembly 28. When combined with instrumentation and display of the vehicle's 1000 current and intended location, the set of equipment enables the operator, whether inside the vehicle, on the ground via datalink, or operating autonomously through the assignment of a pre-planned route, to easily and safely operate and guide the vehicle 1000 to its intended destination.

FIGS. 2A, 2B, 2C and FIG. 2D includes motor and rotor combinations 28, rotors 29 primary flight displays 12, the Automatic Dependent Surveillance-B (ADSB) or Remote ID transmitter/receiver 14, autopilot computer 32, the mission control tablet computers 36 and mission-planning software 34. In each case, a mission control tablet computer or sidearm controllers may transmit the designated route or position command set or the intended motion to be achieved to autopilot computers 32 and voter 42 motor controllers 24, and air data computer to calculate airspeed and vertical speed 38. In some embodiments, fuel tank 22, the avionics battery 27, the pumps and cooling system 44, the turbocharger or supercharger 46, and a starter/alternator may also be included, monitored, and controlled. Any fuel cells 18 are fed by on-board or auxiliary fuel 30 tank 22 and use the fuel to produce a source of power for the multirotor vehicle 1000. The preferred embodiment uses brushless synchronous three-phase AC or DC motors, capable of operating as an aircraft motor, and that are air-cooled, liquid-cooled, or both. A tie-in panel may be installed near the switch equipment that contains connectors such as camlocks. The tie-in panel may also contain a phase rotation indicator (for 3-phase systems) and a circuit breaker. Camlock connectors are rated for 200- and 3000-amp applications and commonly up to 480-volt systems.

The system 1000 implements envelope protection to ensure nothing the vehicle, the human operator/supervisor/passenger, or the environment can do that would push the vehicle out of its safety envelope unless or until there is a failure in some aspect of the system and pre-designed fault tolerance or graceful degradation that creates predictable behavior during anomalous conditions with respect to at least the following systems and components: 1) control hardware; 2) control software; 3) control testing; 4) motor control and power distribution subsystem; 5) motors; 6) fuel cell power generation subsystem and 7) external power supply functions.

Flight control hardware may comprise, for example, a redundant set of Pixhawk or other flight controllers with 32-bit, 64-bit, or greater ARM processors (or other suitable processor known in the art, wherein certain embodiments may employ no processor and instead use an FPGA or similar devices known in the art). The vehicle may be configured with multiple flight controllers, where certain example embodiments employ at least three (3) Pixhawk autopilots disposed inside the vehicle for redundancy. Each autopilot comprises: three (3) Accelerometers, three (3) gyros, three (3) magnetometers, two (2) barometers, and at least one (1) GPS device, although the exact combinations and configurations of hardware and software devices may vary. Sensor combining and voting algorithms internal to each autopilot select the best value from each sensor type and handle switchovers/sensor failures within each autopilot. Flight control software may comprise at least one PID style algorithm that has been developed using: 1) CAD data; 2) FEA data; and 3) actual propeller/motor/motor controller/fuel cell performance data measurements.

An example embodiment is shown for the vehicle's 6 motors, with each motor controlled by a dedicated motor controller 24. Electrical operating characteristics/data for each motor are controlled and communicated to the voting system for analysis and decision making. Communication to the motor controllers 24 happens (in this embodiment) between autopilot and motor controller 24 via CAN, a digital network protocol, with fiber optic transceivers inline to protect signal integrity and provide electromagnetic and lightning immunity. In this embodiment, the use of fiber optics, sometimes known as ‘Fly-by-Light’ increases vehicle reliability and reduces any vulnerability to ground differentials, voltage differentials, electromagnetic interference, lighting, and external sources of electromagnetic interference, such as TV or radio broadcast towers, airport radars, airborne radars, and similar potential disturbances. Other instances of networks and electrical or optical or wireless media are possible as well, subject to meeting regulatory requirements. Measured parameters related to motor performance include motor temperature, IGBT temperature, voltage, current, torque, and revolutions per minute (RPM). Values for these parameters in turn correlate to the thrust expected under given atmospheric, power and pitch conditions.

The fuel cell control subsystem may have various numbers of fuel cells based on the particular use configuration, for example a set of three hydrogen fuel cells configured for fault-tolerance. Operation and control of the cells is enabled and managed using the CAN protocol, although numerous other databus and control techniques are possible and will be obvious to one skilled in the art. One or more flight control algorithms stored within the autopilot will control and monitor the power delivered by the fuel cells via CAN. The triple-modular redundant autopilot can detect the loss of any one fuel cell and reconfigure the remaining fuel cells using a form of automatic switching or cross connection, thus ensuring that the fuel cell system is capable of continuing to operate the vehicle 1000 to perform a safe descent and landing. When the operating parameters are exceeded past a significant extent or preset limit, or emergency conditions exist such that a safe landing is jeopardized, the integrated emergency procedures are activated.

The autopilot computer 32 is embodied in a microprocessor-based circuit and includes the various interface circuits required to communicate with the aircraft's 1000 data busses, multi-channel servo or network controllers (inputs) 35 and 37, and motor controller (outputs) 24, and to take inertial and attitude measurements to maintain stability. This redundant, fault-tolerant, multiple-redundant voting control and communications means and autopilot control unit 32 in relation to the overall system. In addition, autopilot computer 32 may also be configured for automatic recording or reporting of position, vehicle state data, velocity, altitude, pitch angle, bank angle, thrust, location, and other parameters typical of capturing vehicle position and performance, for later analysis or playback. Additionally, recorded data may be duplicated and sent to another computer or device that is fire and crash proof. To accomplish these requirements, said autopilot contains an embedded air data computer (ADC) and embedded inertial measurement sensors, although these data could also be derived from small, separate stand-alone units. The autopilot may be operated as a single, dual, quad, or other controller, but for reliability and safety purposes, the preferred embodiment uses a triple redundant autopilot, where the units share information, decisions and intended commands in a co-operative relationship using one or more networks (two are preferred, for reliability and availability). In the event of a serious disagreement outside of allowable guard-bands, and assuming three units are present, a 2-out-of-3 vote determines the command to be implemented by the motor controllers 24, and the appropriate commands are automatically selected and transmitted to the motor controllers 24. A subset of hardware monitors the condition of the network, a CAN bus in an example embodiment, to determine whether a bus jam or other malfunction has occurred at the physical level, in which case automatic switchover to the reversionary CAN bus occurs. The operator is not typically notified of the controller disagreement during flight, but the result will be logged for further diagnostics post-operation.

The mission control tablet computer 36 is typically a single or a dual redundant implementation, where each mission control tablet computer 36 contains identical hardware and software, and a screen button designating that unit as ‘Primary’ or ‘Backup’. The primary unit is used in all cases unless it has failed, whereby either the operator (if present) must select the ‘Backup’ unit through a touch icon, or an automatic fail-over will select the Backup unit when the autopilots detect a failure of the Primary. When operating without a formal pre-programmed route, the mission control tablet computer 36 uses its internal motion sensors to assess the operator's intent and transmits the desired motion commands to the autopilot. When operating without a mission planning computer or tablet, the autopilots receive their commands from the connected pair of joysticks or sidearm controllers. In UAV mode, or in manned automatic mode, the mission planning software 34 will be used before departure to designate a route, destination, and profile for the vehicle 1000. Flight plans, if entered into the Primary mission control tablet computer 36, are automatically sent to the corresponding autopilot, and the autopilots automatically cross-fill the flight plan details between themselves and the Backup mission control tablet computer 36, so that each autopilot computer 32 and mission control tablet computer 36 carries the same mission commands and intended route. In the event that the Primary tablet fails, the Backup tablet already contains the same details, and assumes control of the vehicle once selected either by operator action or automatic fail-over.

For motor control of the multiple motors and rotors 29, there are three phases that connect from each high-current controller to each motor for a synchronous AC or DC brushless motor. Reversing the position of any two of the 3 phases will cause the motor to run the opposite direction. There is alternately a software setting within the motor controller 24 that allows the same effect, but it is preferred to hard-wire it, since the designated motors running in the opposite direction must also have rotors with a reversed pitch (these are sometimes referred to as left-hand vs right-hand pitch, or puller (normal) vs pusher (reversed) pitch rotors, thereby forming the multiple motors and rotors 29. Operating the motors in counter-rotating pairs cancels out vehicle rotational torque.

In the illustrated embodiment, the operational analyses and control algorithms are performed by the onboard autopilot computer 32, and path and other useful data are presented on the displays 12.

The redundant communication systems are provided in order to permit the system to survive a single fault with no degradation of system operations or safety. In this real-time system, the autopilot computers 32 voting process that is implemented with the fault-tolerant, triple-redundant voting control, and communications means to perform the qualitative decision process instead share data and the desired parameters for operating the vehicle by cross-filling the operation plan, and each measures its own state-space variables that define the current vehicle 1000 state, and the health of each node. Each node independently produces a set of motor control outputs (in serial CAN bus message format in the described embodiment), and each node assesses its own internal health status. The results of the health-status assessment are then used to automatically select which of the autopilots actually are in control of the motors of the multiple motors and rotors 29. More than a single fault initiates emergency system implementation.

Multi-way voter implemented using analog switch monitors the state of 1.0K, 2.0K and 3.0K and uses those 3 signals to determine which serial signal set to enable so that motor control messages may pass between the controlling node and the motor controllers 24, fuel cell messages may pass between the controlling node and the fuel cells, and joystick messages may pass between the controlling node and the joysticks. This controller serial bus is typified by a CAN network in the preferred embodiment, although other serial communications may be used such as PWM pulse trains, RS-232, Ethernet, or a similar communication means. In an alternate embodiment, the PWM pulse train is employed; with the width of the PWM pulse on each channel being used to designate the percent of RPM that the motor controller 24 should achieve. This enables the controlling node to issue commands to each motor controller 24 on the network. Through voting and signal switching, the multiple (typically one per motor plus one each for any other servo systems) command stream outputs from the three autopilot computers can be voted to produce a single set of multiple command streams, using the system's knowledge of each autopilot's internal health and status.

The system 100 provides sensing devices or safety sensors that monitor the various subsystems, and including the at least one fuel cell module, the circuits powering the amplifying subsystem 111, and the plurality of motor controllers, each configured to self-measure and report parameters using a Controller Area Network (CAN) bus to inform the one or more autopilot control units 32 or computer units (CPUs) as to a valve, pump or combination thereof to enable to increase or decrease of fuel supply or cooling using fluids wherein thermal energy is transferred from the coolant, wherein the one or more autopilot control units 32 comprise at least two redundant autopilot control units that command the plurality of motor controllers 24, the fuel supply subsystem, the at least one fuel cell module 18, and fluid control units with commands operating valves and pumps altering flows of fuel, air and coolant to different locations, and wherein the at least two redundant autopilot control units 32 communicate a voting process over a redundant network where the at least two redundant autopilot control units 32 with CPUs provide health status indicators. The signals and analog voting circuit compute the overall health of e.g., fuel cell modules by determining from the individual health status indicators whether all nodes are good, a particular node is experiencing a fault, a series of fault are experienced, or the system is inoperative (or other similar indications based on aggregation of individual signals and cross check verification). Results of voting then trigger appropriate signals sent to control e.g., fuel cell modules 18 or motor controllers 24.

The system takes measurements of various sensor outputs (e.g., RPM, motor voltage, motor current, temperature, or thermodynamic operating conditions) indicative of performance of each of the multiple motors and rotors 29. Measurement data may be readily accessed through each motor controller's 24 serial data busses. The system performs various analyses on the data, which may be used to calculate each motor's thrust and contribution to vehicle motion. The system then measures the throttle command, by detecting where the tablet throttle command or throttle lever has been positioned by the operator and notes any change in commanded thrust from prior samples. The system and autopilot computers 32 gather a representative group of vehicle 1000 measurements (voltage, current drawn and estimated remaining fuel 30, air speed, vertical speed, pressure altitude, GPS altitude, GPS latitude and GPS longitude, outside-air temperature (OAT), pitch angle, bank angle, yaw angle, pitch rate, bank rate, yaw rate, longitudinal acceleration, lateral acceleration, and vertical acceleration) from embedded inertial sensors and/or other onboard sensors including air data sensors, and GPS data derived by receiving data from embedded GPS receivers. This data is made available to the operator then used as part of the analysis of remaining operation duration for the trip or mission underway (including external supply of electrical power), wherein the system examines the intended matrix of commands, assesses whether the intended actions are within the vehicle's 1000 safety margins and/or whether the electrical system and fuel tank 22 contain sufficient power to accomplish the mission with margins and without compromising the overall success of the mission, and if not, makes adjustments to the matrix of motor controller 24 commands and provides an indication of any necessary updates to the operator Display to indicate that vehicle performance has been adjusted, then issues network messages to indicate its actions and status to the other autopilot nodes. The system then captures all of the vehicle performance and state data and determines whether it is time to store an update sample to a non-volatile data storage device on-board storage (that may contain the data in a comma-delimited or other simple file format), typically a flash memory device or other form of permanent data storage, and returns to await the next tick, when the entire sequence is repeated. Some or all of the position and control instructions can be performed outside the vehicle 1000, by using a broadband or 802.11 Wi-Fi network or Radio Frequency (RF) data-link or tactical datalink mesh network or similar between the vehicle 1000 and the external equipment. They may also be examined and/or downloaded using a web server interface or transmitted to a ground station using tactical datalinks, commercial telecom (i.e., 4G, 5G or similar), Wi-Fi, or Satellite (SatCom) services such as Iridium.

The present invention's approach to vehicle operation and control, including the ability of the vehicle to operate with redundant motor capacity, redundant fuel cell capability, and to be operated by a triple-redundant autopilot provides increased safety and stability for both piloting vehicles to locations and performing power generation and communication supply functions while operating at the desired locations.

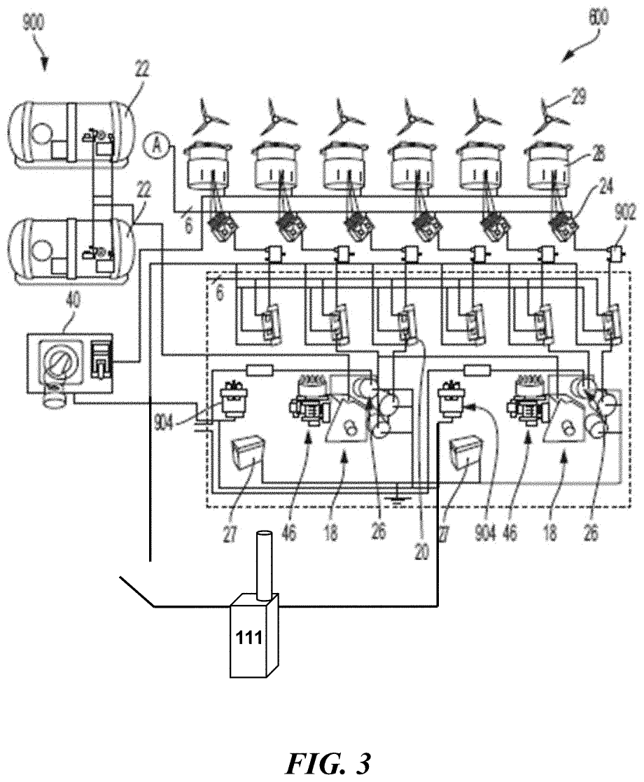

FIG. 3 depicts electrical and systems connectivity of various motor control components of a system of the invention, as well as an example fuel supply subsystem 900 for the vehicle 1000. The electrical connectivity includes six motor and rotor assemblies 28 (of a corresponding plurality of motors and rotors 29) and the electrical components needed to supply the motor and rotor combinations with power. A high current contactor 904 is engaged and disengaged under control of the vehicle key switch 40, which applies voltage to the starter/generator 26 to start the fuel cell modules 18. In accordance with an example embodiment of the present invention, after ignition, the fuel cell modules 18 (e.g., one or more hydrogen-powered fuel cells or hydrocarbon-fueled motors) create the electricity to power the six motor and rotor assemblies 28 (of multiple motors and rotors 29). A power distribution monitoring and control subsystem with circuit breaker 902 autonomously monitors and controls distribution of the generated electrical voltage and current from the fuel cell modules 18 to the plurality of motor controllers 24. As would be appreciated by one skilled in the art, the circuit breaker 902 is designed to protect each of the motor controllers 24 from damage resulting from an overload or short circuit. Additionally, the electrical connectivity and fuel supply subsystem 900 includes diodes or FETs 20, providing isolation between each electrical source and an electrical main bus and the fuel cell modules 18. The diodes or FETs 20 are also part of the fail-safe circuitry, in that they diode-OR the current from the two sources together into the electrical main bus. For example, if one of the pair of the fuel cell modules 18 fails, the diodes or FETs 20 allow the current provided by the now sole remaining current source to be equally shared and distributed to all motor controllers 24. Such events would clearly constitute a system failure, and the autopilot computers 32 would react accordingly to land the aircraft safely as soon as possible. Advantageously, the diodes or FETs 20 keep the system from losing half its motors by sharing the remaining current. Additionally, the diodes or FETs 20 are also individually enabled, so in the event that one motor fails or is degraded, the appropriate motor and rotor combinations 28 (of multiple motors and rotors 29—e.g., the counter-rotating pair) would be disabled. For example, the diodes or FETs 20 would disable the enable current for the appropriate motor and rotor combinations 28 (of multiple motors and rotors 29) to switch off that pair and avoid imbalanced thrust. In accordance with an example embodiment of the present invention, the six motor and rotor combinations 28 (of multiple motors and rotors 29) each include a motor and a propeller 29 and are connected to the motor controllers 24, that control the independent movement of the six motors of the six motor and rotor combinations 28. Similarly, the power transfer switch is interconnected with these components to maintain current and voltage supply as part of the fail-safe circuitry. As would be appreciated by one skilled in the art, the electrical connectivity and fuel supply subsystem 900 may be implemented using 6, 8, 10, 12, 14, 16, or more independent motor controllers 24 and motor and rotor assemblies 28 (of a plurality of motors and rotors 29).

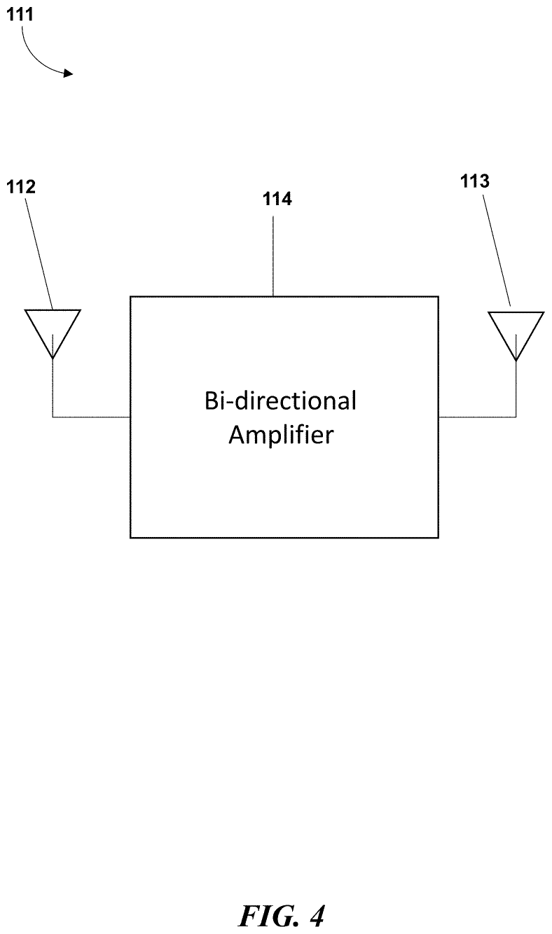

Continuing with FIG. 3, the electrical connectivity and fuel supply subsystem 900 also depicts the redundant battery module system as well as components of the DC and/or AC power generation subsystem 600. The electrical connectivity and fuel supply subsystem 900 includes the fuel tank 22, the avionics battery 27, the pumps (e.g., water or fuel pump) and cooling system 44, the supercharger 46, and a starter/alternator. The fuel cells 18 are fed by onboard or auxiliary fuel 30 tank 22 and use the fuel to produce a source of power for the motor and rotor combinations 28. The power generation subsystem 600 also includes a cell site subsystem 111. As would be appreciated by one skilled in the art, the fuel cell modules 18 can include one or more hydrogen-powered fuel cells that can be fueled by hydrogen or other suitable gaseous fuel 30, to drive or turn multiple motors and rotors 29 and power cell site subsystem 111. An example of one such cell site subsystem 111 can be seen in FIG. 4.

The cell site subsystem 111 of FIG. 4 includes at least a donor/reception antenna 112, a rebroadcasting/service antenna 113, and a bi-directional amplifier 114. In certain embodiments, the bi-directional amplifier 114 may further include appropriate software and logic to function using existing vehicle control infrastructure (where existing vehicle electronic components may be reprogrammed or repurposed to transform into communication amplification components for specific applications). The cell site subsystem 111 components may comprise an array of external antennae or components of existing onboard communications equipment. In example embodiments, the antennae 112/113 may be omnidirectional antennae and may be removably or permanently connected to the top, sides, bottom, front or back of the vehicle 1000, or within specified components onboard the vehicle 100, where these elements are in electronic communication with vehicle mission control computers 36, autopilot control units 32 and are part of electrical power supply circuits that are selectively activated and connected to the vehicle power generation subsystems comprising one or more fuel cell modules to provide electrical power (voltage and current) to the appropriate required parameters. These parameters may vary according to voltage and current rating, shape, size, and connector type. Different standard communication components, such as commercial cell repeaters, may be employed based on particular jurisdiction regulation, as understood by one of skill in the art. Various insulating, disconnecting (circuit breaking, GFCI), attenuating and grounding components are included to prevent harm to users and to reduce signal noise or interference by isolating incoming and outgoing signal processing (via interference cancellation equipment). To reduce the risk of electric shock, subsystems and components may have safety features including insulated sleeves, recessed sockets, and/or automatic shutoffs. The array of antennae and wireless communication equipment of the cell site subsystem 111 can be activated by an onboard control tablet 36 or activation switch in electronic communication with the at least one electrical circuit of the at least one fuel cell module and controlling distribution of electrical power between vehicle propulsion and/or the cell site subsystem 111. Additional activation means known in the art, including remote or autonomous activation through vehicle or external processors and wireless signaling may be incorporated into the system. Cell site subsystem 111 component indicators or power indicators may also be included, comprising e.g., one or more light-emitting diodes (LEDs) that are displayed or illuminated when power is being supplied to the cell site subsystem 111 while it functions as e.g., a cellular repeater (bi-directional amplifier used to improve cell phone reception). External feedback mechanisms including visual displays, exterior or surface lights, and display screens can be programmed by the system to convey information to internal or external users that may include indication of operational repeater services or instructions for how to access and use the amplification functions of the repeater (e.g., in an implementation for a mobile hotspot situated within an emergency communication area). The cell site subsystem 111 elements may further comprise surge protectors, spike suppressors, lightning arrestor subsystems or other safety components known in the art. The logic controlling the onboard power supply for propulsion and electronics controls the function of the cell site subsystem 111 as well in a unitary, integrated, and consolidated system to improve efficiency, convenience and responsiveness while minimizing payload.

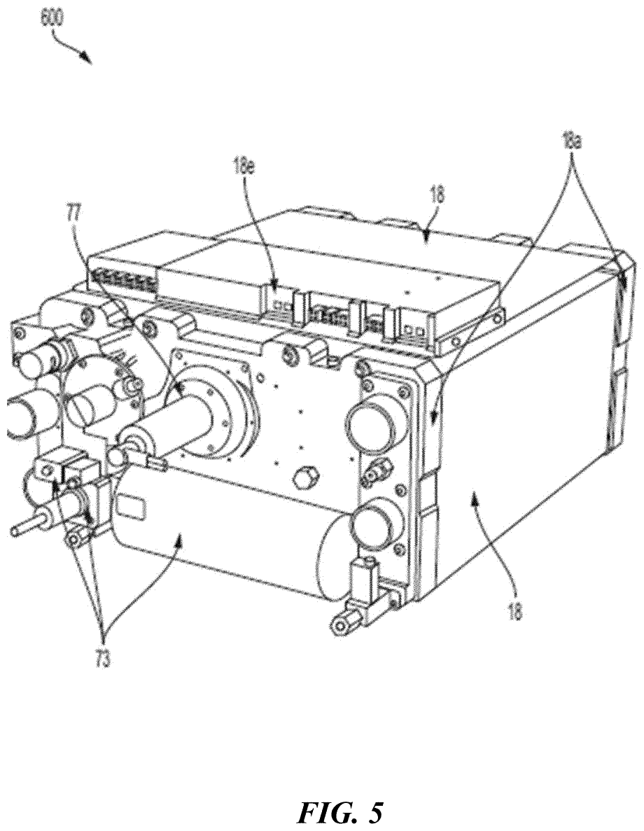

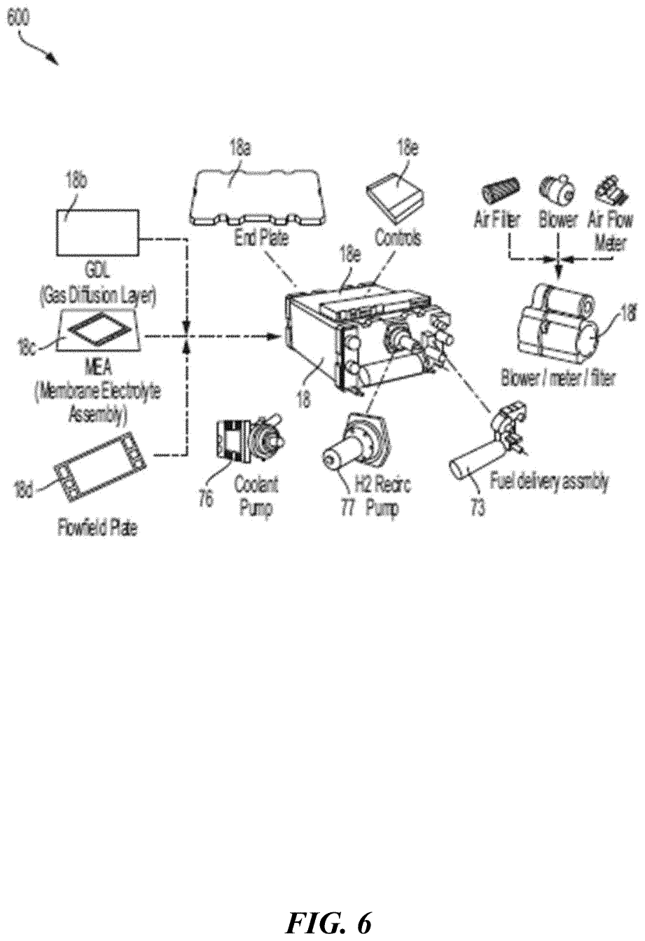

FIGS. 5, 6, and 7 depict example subcomponents of fuel cell modules 18 within the power generation subsystems 600 of the vehicle 1000. FIG. 5 depicts example configurations of fuel cells within the vehicle 1000, and FIG. 6 depicts example subcomponents of fuel cells in at least one fuel cell module 18 within the vehicle 1000. In one embodiment the one or more fuel cell modules 18 comprise an air filter 18f, blower 18f, airflow meter 18f, fuel delivery assembly 73, recirculation pump 77, coolant pump 76, fuel cell controls 18e, sensors, end plate 18a, at least one gas diffusion layer 18b, at least one membrane electrolyte assembly 18c, at least one flowfield plate 18d, coolant conduits 84, connections, a hydrogen inlet 82, a coolant inlet, a coolant outlet 79, one or more air-driven turbochargers 46 supplying air to the one or more fuel cell modules 18, and coolant conduits 84 connected to and in fluid communication with the one or more fuel cell modules 18 and transporting coolant 31. The one or more fuel cell modules 18 may further comprise one or more hydrogen-powered fuel cells, where each hydrogen-powered fuel cell is fueled by gaseous hydrogen (GH₂) or liquid hydrogen (LH₂) and wherein the one or more fuel cell modules 18 combines hydrogen from the fuel tank 22 with air to supply electrical voltage and current. Fuel cell vessels and piping are designed to the ASME Code and DOT Codes for the pressure and temperatures involved.

In one embodiment, a fuel cell module 18 comprises a multi-function stack end plate that is configured for reduced part count, comprising an integrated manifold, integrated wiring harnesses, integrated electronics, and controls, wherein the stack endplate eliminates certain piping and fittings and allows easier part inspection and replacement, yielding improved reliability, significant mass, volume and noise reduction, and reduction in double-wall protection. The integrated electronics and controls may operate as temperature sensors or thermal energy sensors for the fuel cell modules 18. The fuel cell module 18 may be further configured of aerospace lightweight metallic fuel cell components, with a stack optimized for: reduced weight; increased volumetric power density; extreme vibration tolerance; improved performance and fuel efficiency; increased durability; and combinations thereof. In an example embodiment, a fuel cell module 18 may produce 120 kW of power, in a configuration with dimensions of 72×12×24 inches (L×H×W) and a mass of less than 120 kg, with a design life greater than 10,000 hours. The operation orientation of each module accommodates roll, pitch, and yaw, as well as reduction in double-wall protection and shock & vibration system tolerance.

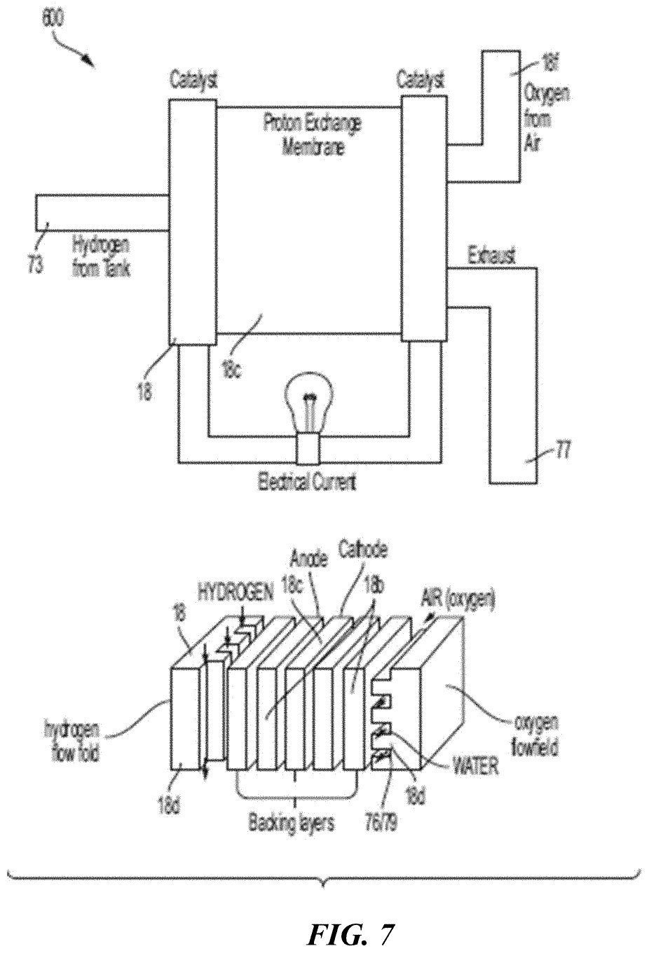

FIG. 7 depicts example subcomponents inside fuel cell modules 18 covered by an end plate 18a, demonstrating the configuration of hydrogen flowfield plates and oxygen flowfield plates 18d, anode and cathode volumes on each side of the proton exchange membrane 18c of the membrane electrolyte assembly with backing layers and catalysts, as well as resulting hydrogen, oxygen, and coolant flow vectors. Gaseous hydrogen fuel enters via a delivery assembly 73, oxygen (02), or air (supplied by oxygen delivery component) enters as output from an air filter/blower/meter 18f, and exhaust fluids can be removed via recirculation pump 77. Catalyst layers may be adhered at the electrode/electrolyte interface. Liquid water may be formed at the cathode in the catalyst layer at the electrode/electrolyte interface, which hinders fuel cell performance when not removed, where it hinders O₂ from getting to electrode/electrolyte interface, causing limitations in max current density. A Gas diffusion layer (GDL) 18b may be implemented to permit H₂O to be removed without hindering gas transport. The GDL 18b is porous to permit flow to the electrode/electrolyte interface & sufficient conductivity to carry the current generated and allow water vapor diffusion through the GDL 18b and convection out the gas outflow channels, circulating electrolyte and vaporizing water, but not be liquid H₂O permeable. A GDL 18b may be electrically conductive to pass electrons between the conductors that make up the flow channels and comprise both a backing layer and mesoporous layer. Compressed O₂/air also flows through gas flow channels, diffuses through a GDL 18b, to a catalyst layer where it then reacts with ions or protons coming through an electrolyte layer or assembly. Common electrolyte types include alkali, molten carbonate, phosphoric acid (liquid electrolytes), solid oxide (solids), and proton exchange membrane (PEM) 18c. Liquid electrolytes are held between the two electrodes. A PEM 18c is held in place using membrane electrolyte assembly (MEA) 18c. A PEM 18c (PEMFC) most often uses a water-based, acidic polymer membrane as its electrolyte, with platinum-based electrodes.

In operation, LH₂ converted to GH₂ by extraction using change in pressure or one or more heat exchangers 57, and a compressed air/O₂ flow from turbochargers or superchargers 46 (or conventional fuel pumps and regulators or local storage of air or oxygen) by way of an air filter/blower/meter 18f, are supplied to one or more fuel cell modules 18 that comprise one or more fuel cell stacks of a plurality of hydrogen fuel cells. In each fuel cell of the plurality of hydrogen fuel cells GH₂ fuel from a delivery assembly 73 enters a first end of a hydrogen flowfield plate 18d inflow at an inlet and is fed through flow channels in the hydrogen flowfield plate 18d that comprise a channel array designed to distribute and channel hydrogen to an anode layer. Excess GH₂ may be directed to bypass the rest of the fuel cell and exit a second end of that flowfield plate 18d via GH₂ outflow at an outlet that may be further connected to and in fluid communication with fluid conduits, valves, and recirculation pumps 77 to recycle the hydrogen for future fuel cell reactions (or may be vented using an exhaust port 66). In each fuel cell O₂ contained within or extracted from compressed air from a turbocharger or supercharger 46 enters a first end of oxygen flowfield plate 18d inflow using an inlet and is fed through flow channels traversing the flowfield plate 18d in a direction at a perpendicular angle to the flow of GH₂ in the respective opposite flowfield plate 18d of the pair of plates in each fuel cell, through a channel array designed to distribute and channel oxygen to a cathode layer. Excess O₂ may be directed to bypass the rest of the fuel cell and exit a second end of that flowfield plate 18d via O₂ and/or H₂O outflow at an outlet that may be further connected to and in fluid communication with fluid conduits, valves, and recirculation pumps 77 to recycle the oxygen for future fuel cell reactions (or may be vented as exhaust using an exhaust port 66). Each of the gases GH₂ and O₂ are diffused through two distinct GDLs 18b disposed on both sides of the fuel cell opposite each other (so net flow is toward each other and the center of the fuel cell), separated by two layers of catalyst further separated by plastic membrane such as a PEM 18c. An electro-catalyst, which may be a component of the electrodes at the interface between a backing layer and the plastic membrane catalyst, splits GH₂ molecules into hydrogen ions or protons and electrons using a reaction that may include an oxidation reaction. In one embodiment, at the anode of an anode layer, a platinum catalyst causes the H₂ dihydrogen is split into H+ positively charged hydrogen ions (protons) and e− negatively charged electrons. The PEM 18c allows only the positively charged ions to pass through it to the cathode, such that protons attracted to the cathode pass through PEM 18c while electrons are restricted where the PEM electrolyte assembly (MEA) acts as a barrier for them. The negatively charged electrons instead travel along an external electrical circuit to the cathode, following a voltage drop, such that electrical current flows from anode side catalyst layer to cathode side catalyst layer creating electricity to power the vehicle 1000 components that is directed to storage or directly to a plurality of motor controllers 24 to operate a plurality of motor and rotor assemblies 28. At contact with the platinum electrode as the electrons pass through the GDL after being distributed by flowfield plate 18d, one or more current collectors may be employed to facilitate flow of electrons into the external electrical circuit, which may be comprised of metallic or other suitable conductive media and directed to circumvent the MEA and arrive at the cathode layer. After traveling through the external electrical circuit electrons are deposited at the cathode layer where electrons and hydrogen ions or protons with O₂ in the presence of a second catalyst layer to generate water and heat. Electrons combine with O₂ to produce O₂ ions and then hydrogen ions or protons arriving through the PEM 18c combine with the ions of O₂ to form H₂O. This H₂O is then transported back across the cathode side catalyst layer through a GDL into O₂ flow channels where it can be removed or otherwise convected away with air flow to exit a second end of that flowfield plate 18d via O₂ and/or H₂O outflow at an outlet that may be further connected to and in fluid communication with fluid conduits, valves, or pumps and may be vented as exhaust using an exhaust port 66 that may be used for other exhaust gases or fluids as well. Thus, the products of the fuel cells are only heat, water, and the electricity generated by the reactions. In other embodiments, additional layers may alternatively be implemented such as current collector plates or GDL compression plates.

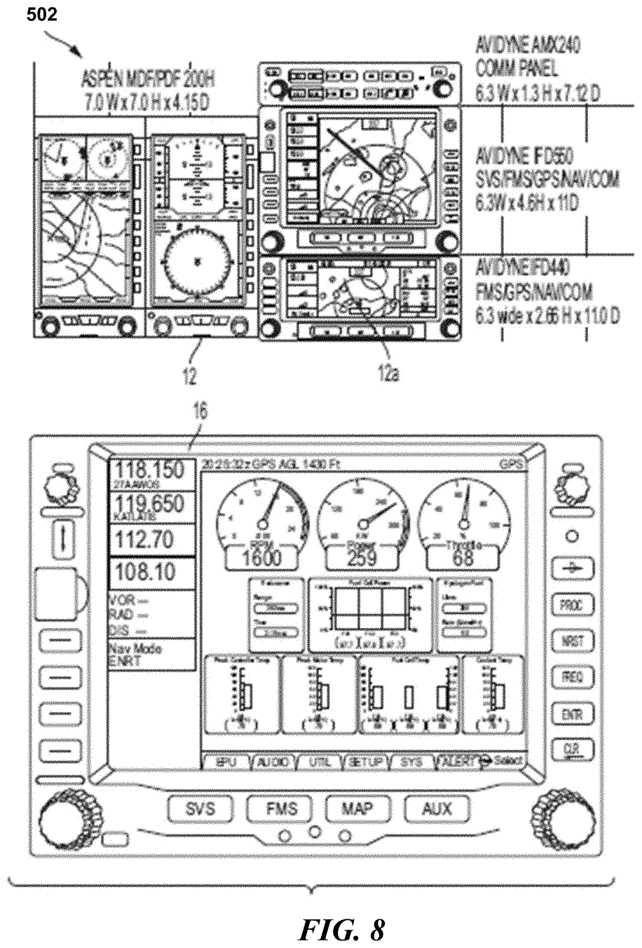

FIG. 8 depicts one kind of display presentation 502 that can be provided to show fuel cell operating conditions including fuel remaining, fuel cell temperature and motor performance related to each of the respective fuel cell modules 18 (bottom) as well as weather data (in the right half). Other screens can be selected from a touch-sensitive row of buttons along the lower portion of the screen. FIG. 8 shows the use of available TSO′d (i.e., FAA approved) avionics units, adapted to this vehicle and mission. A simpler form of avionics (known as Simplified Vehicle Operations or SVO) may be introduced, where said display is notionally a software package installed and operating on a ‘tablet’ or simplified computer and display, similar to an Apple iPad®. The use of two identical units running identical display software allows the user to configure several different display presentations, and yet still have full capability in the event that one display should fail during operation. This enhances the vehicle's overall safety and reliability.

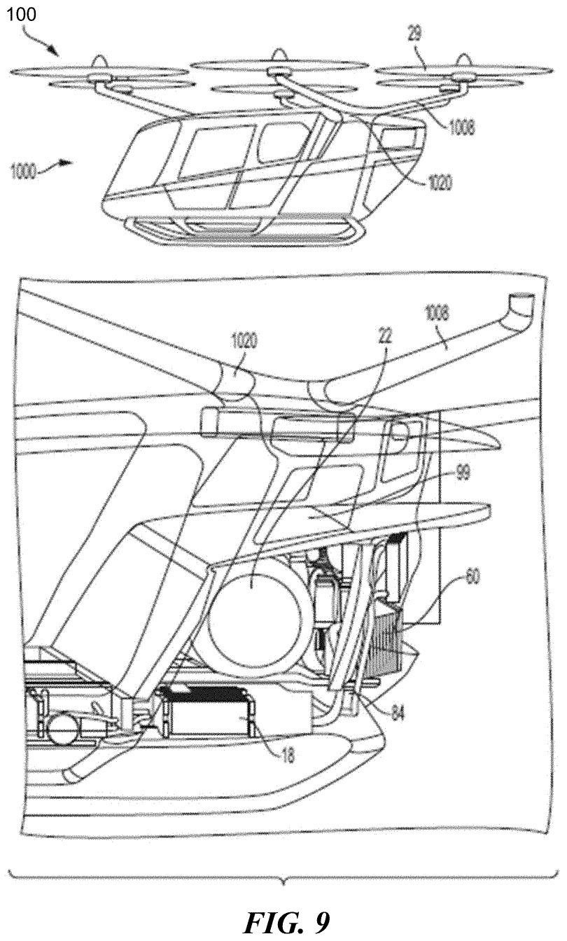

FIG. 9 depicts an example profile diagram of the fuel supply subsystem 900 components within the vehicle 1000 in relation to the power generation subsystem 600 components positioned on the opposite side of the fire wall 99. In some embodiments, fuel tank 22, the avionics battery 27, various pumps and cooling system 44, supercharger 46, and radiators 60 may also be included, monitored, and controlled. Any fuel cell modules 18 are fed by on-board fuel tank 22 and use the fuel 30 to produce a source of power for the vehicle 1000. Operation and control of the cells is enabled via CAN protocol or a similar databus or network or wireless or other communications means. Control algorithms will modulate and monitor the power delivered by fuel cells via CAN.

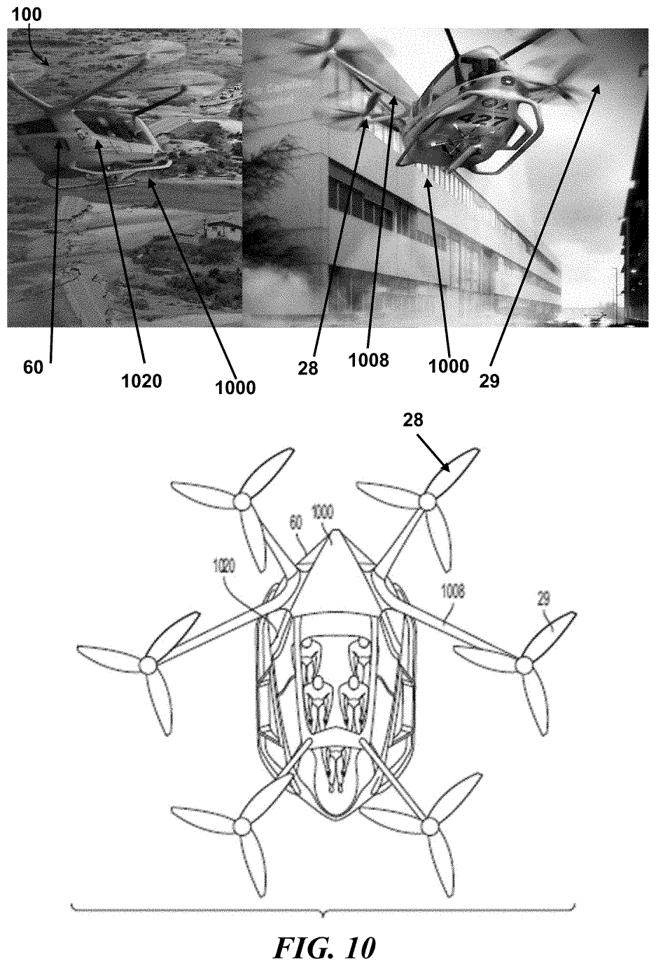

FIG. 10 depicts side and top views of an example vehicle 1000 that is a multirotor aircraft in accordance with an embodiment of the present invention and comprises elongate support arms 1008 and an aircraft body 1020. In accordance with an example embodiment of the present invention, the multiple electric motors are supported by the elongate support arms 1008, and when the vehicle 1000 is elevated, the elongate support arms 1008 support (in suspension) the vehicle 1000 itself, enabling delivery of power to otherwise inaccessible locations such as the tops of buildings or mountains.

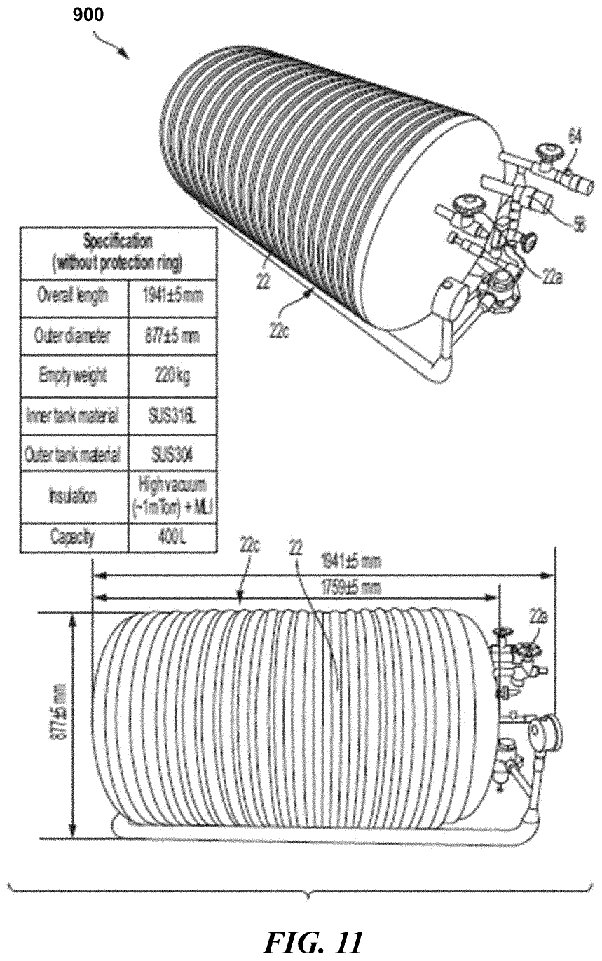

FIG. 11 depicts example subcomponents of fuel tanks 22 and fuel supply subsystem 900 within the vehicle 1000. Example embodiments of the liquid hydrogen storage subsystem and fuel tank 22 of the fuel supply subsystem 900 may further comprise a carbon fiber epoxy shell or stainless steel or other robust shell, a plastic or metallic liner, one or more inner tanks, an insulating wrap, a vacuum between inner and outer tank, a metal interface, and crash/drop protection including at least one protection ring. In the integrated system 100 fuel supply subsystem 900, the fuel tank 22 is in fluid communication with one or more fuel cells and modules 18, fuel lines 85, and at least one fuel supply coupling 58 with refueling connections for charging, with vessels and piping 85 designed to the ASME Code and DOT Codes for the pressure and temperatures involved and all configured to store and transport a working fluid as a fuel 30 selected from the group consisting of gaseous hydrogen (GH₂), liquid hydrogen (LH₂), or similar fluid fuels know in the art. Working fluids may include: fuel 30 in liquid or gaseous state, coolant 31, pressurized or other air that may or may not be heated. The head side of the fuel tank 22 comprises multiple valves 88 and instruments for operation of the fuel tank 22, including but not limited to: mating part A with LH₂ refueling port (Female part of at least one fuel transfer coupling 58 for charging lines used to fill the fuel tank 22 with liquid hydrogen (LH₂) to the stated amount); mating part B including a ⅜″B(VENT 64), ¼″(PT), ¼″ (PG&PC), feed through, vacuum port, vacuum gauge, spare port, ¼″sensor (Liquid detection); and mating part C including at least one 1 inch union 86 and a discharge line (to interface with heat exchangers 57) as well as ½″safety valves 88, 1 bar vent 64 for charging and to maintain fuel safety and delivery continuity a vaporizer 72 and one or more GH₂ vent 64 connections and venting 64 from the component/mechanical compartment to an external temperature zone 54; one or more self-pressure build up units; at least two pressure safety relief valves 88; at least one vacuum sensor and port, at least one level sensor (High Capacitance) and a level sensor feed through, pressure transmitters, pressure regulators, pressure sensors, pressure gauges, connectors, solenoid valves, one or more temperature sensors or sensing devices or thermal safety sensors, GH₂ heating components; radiator 60; and coolant circulation pumps, vessels and piping routed to a heat exchanger 57 or in contact with fluid conduits for fuel cell coolant 31 water.

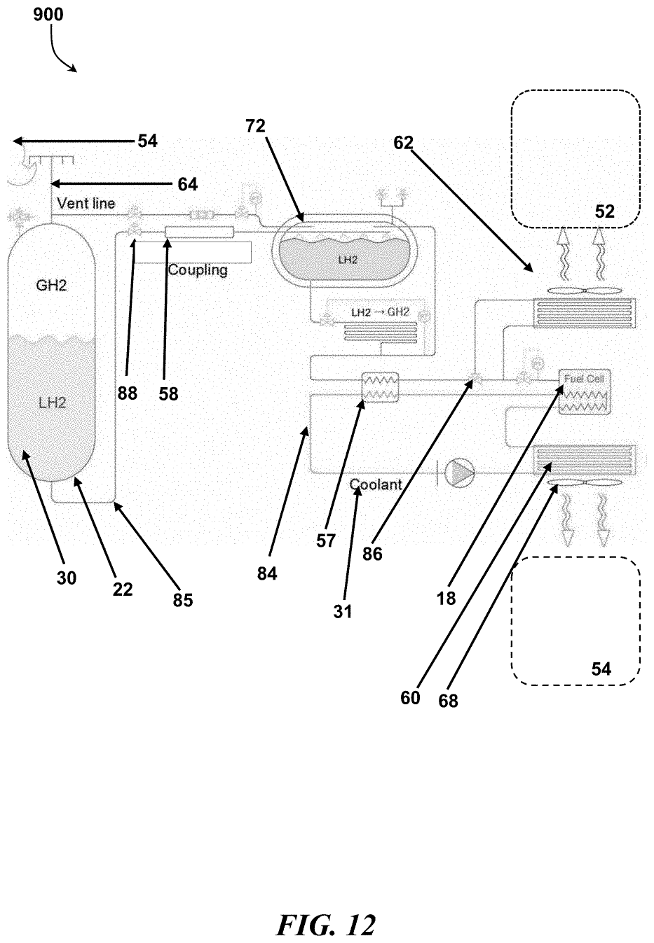

FIG. 12 depicts an example diagram of the fuel supply subsystem 900 including the fuel tank 22, fuel cell, radiator 60, heat exchanger 57 and air conditioning components, along with the most basic components of the power generation subsystem 600. The integrated system 100 fuel supply subsystem 900 further comprises the fuel tank 22 in fluid communication with one or more fuel cells, configured to store and transport a fuel selected from the group consisting of gaseous hydrogen (GH₂), liquid hydrogen (LH₂), or similar fluid fuels. The fuel supply subsystem 900 further comprises fuel lines, at least one fuel supply coupling 58, refueling connections for charging, one or more vents 64, one or more valves 88, one or more pressure regulators, the vaporizer 72, unions 86, and the heat exchanger 57, each in fluid communication with the fuel tank 22, and wherein the one or more temperature sensing devices or thermal safety sensors monitor temperatures and concentrations of gases in the fuel supply subsystem 900, and also comprise one or more pressure gauges, one or more level sensors, one or more vacuum gauges, and one or more temperature sensors. The autopilot control unit 32 or a computer processor are further configured to operate components of the subsystems and compute, select and control, based on the temperature adjustment protocol, an amount and distribution of thermal energy transfer including: from the one or more sources comprising the power generation subsystem 600, to the one or more thermal energy destinations including: the internal temperature zone 52 (using HVAC subsystems 62), the external temperature zone 54 (using at least the at least one radiator 60, one or more fans 68 and/or the one or more exhaust ports 66), and the fuel supply subsystem 900 (using the thermal energy interface subsystem 56 comprising the heat exchangers 57 or a vaporizer 72). Distribution may occur from the one or more sources comprising the internal temperature zone 52, to the one or more thermal energy destinations comprising the fuel supply subsystem 900, using the HVAC subsystems; or from the external temperature zone 54, to the fuel supply subsystem 900, using one or more vents; and combinations thereof. FIG. 12 depicts the LH₂ 400 L fuel tank 22 together with pressure build up unit, LH₂ Alt Port, refueling port, pressure gauge w/switch contact, pressure trans/level/vacuum gauge/pressure regulator, Vaporizer 72 for converting LH₂ to GH₂ and mating part A: LH₂ refueling port (female fuel transfer coupling 58); mating part B; ⅜″ B (Vent 64); mating part C 1″ union 86 (interface w/ heat exchanger 57). Also depicted are the at least one radiator 60, coolant outlet, example fuel cell module 18, coolant inlet 78, air flow sensing and regulation, and coolant (cooling water circulation) pump 76. The thermal energy interface subsystem depicted in FIG. 12 comprising the heat exchanger 57 or a vaporizer 72, configured to connect to a first fluid conduit in connection with and in fluid communication the fuel supply subsystem 900 comprising the fuel 30, and a second conduit in connection with and in fluid communication with the power generation subsystem 600 comprising the coolant 31, wherein thermal energy is transferred from the coolant 31, across a conducting interface by conduction, and to the fuel 30, thereby warming the fuel 30 and cooling the coolant 31, and wherein the one or more temperature sensing devices or thermal energy sensing devices further comprises a fuel temperature sensor and a coolant temperature sensor.

In one embodiment, the fuel cell control system 100 comprises 6 motors and 3 fuel cell modules 18, one fuel cell for each 2-motor pair. The fuel cell modules 18 are triple-modular redundant autopilot with monitor, Level A analysis of source code, and at least one cross-over switch in case of one fuel cell failure.

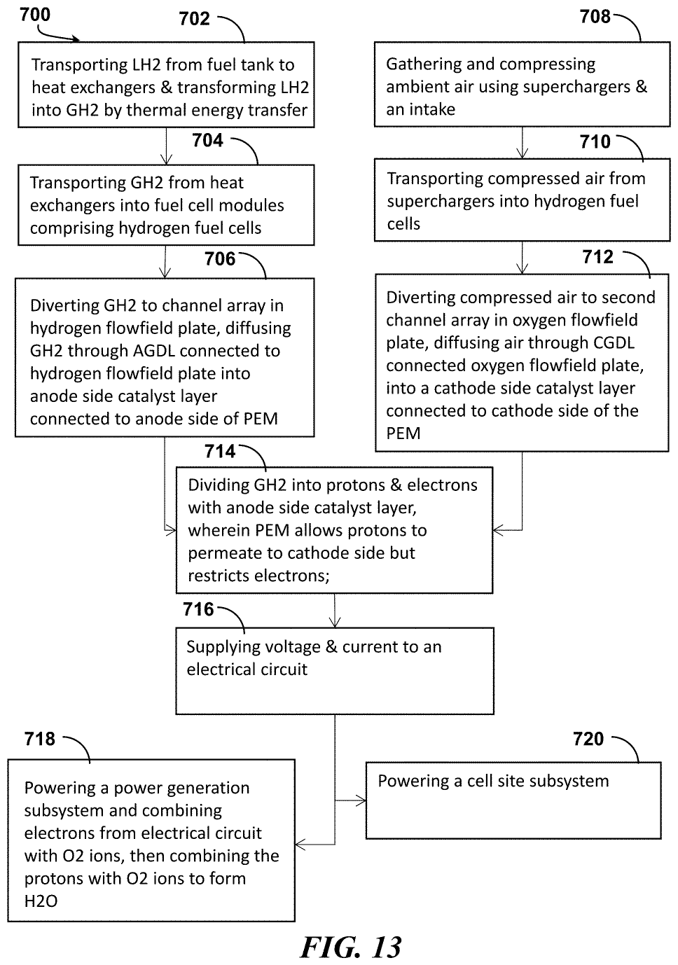

FIG. 13 depicts a flow chart that illustrates the present invention in accordance with one example embodiment of a method 700 for operating lightweight, high power density, fault-tolerant fuel cell systems in a clean fuel vehicle 1000 used to power the vehicle 1000 and the cell site subsystem 111. The method 700 comprises: at Step 702 transporting liquid hydrogen (LH₂) fuel from a fuel tank 22 to one or more heat exchangers 57 in fluid communication with the fuel tank 22 and transforming the state of the LH₂ into gaseous hydrogen (GH₂); and Step 704 transporting the GH₂ from the one or more heat exchangers 57 into one or more fuel cell modules 18 comprising a plurality of hydrogen fuel cells in fluid communication with the one or more heat exchangers 57. The method steps further comprise at Step 706 diverting the GH₂ inside the plurality of hydrogen fuel cells into a first channel array embedded in an inflow end of a hydrogen flowfield plate 18d in each of the plurality of hydrogen fuel cells, forcing the GH₂ through the first channel array, diffusing the GH₂ through an anode backing layer comprising an anode Gas diffusion layer (AGDL) 18b in surface area contact with, and connected to, the first channel array of the hydrogen flowfield plate 18d, into an anode side catalyst layer connected to the AGDL and an anode side of a proton exchange membrane (PEM 18c) of a membrane electrolyte assembly (MEA) 18c. At Step 708 the system 100 performs gathering and compressing ambient air into compressed air using one or more turbochargers or superchargers 46 in fluid communication with an intake. The system 100 performs, at Step 710 transporting compressed air from the one or more turbochargers or superchargers 46 into the one or more fuel cell modules 18 comprising the plurality of hydrogen fuel cells in fluid communication with the one or more turbochargers or superchargers 46; and at Step 712 diverting compressed air inside the plurality of hydrogen fuel cells into a second channel array embedded in an inflow end of an oxygen flowfield plate 18d in each of the plurality of hydrogen fuel cells disposed opposite the hydrogen flowfield plate 18d, forcing the GH₂ through the second channel array, diffusing the compressed air through a cathode backing layer comprising a cathode gas diffusion layer (CGDL) 18b in surface area contact with, and connected to, the second channel array of the oxygen flowfield plate 18d, into a cathode side catalyst layer connected to the CGDL and a cathode side of the PEM 18c of the membrane electrolyte assembly. At Step 714 dividing the LH₂ into protons or hydrogen ions of positive charge and electrons of negative charge through contact with the anode side catalyst layer, wherein the PEM 18c allows protons to permeate from the anode side to the cathode side through charge attraction but restricts other particles comprising the electrons; at Step 716 supplying voltage and current to an electrical circuit; at Step 718 the power subsystem 600 selectably powers a power generation subsystem comprising a plurality of motor controllers 24 configured to control a plurality of motor and propeller or rotor assemblies 28, and combining electrons returning from the electrical circuit with oxygen in the compressed air to form oxygen ions, then combining the protons with oxygen ions to form H₂O molecules; At Step 720 the power subsystem selectably powers the cell site subsystem 111 to provide wireless communication functionality.

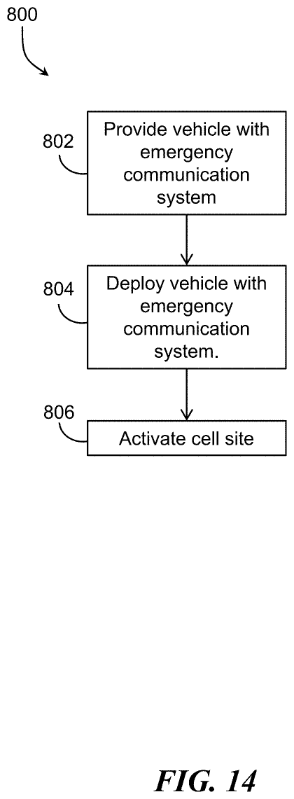

FIG. 14 depicts a flow chart for providing emergency communications in accordance with an example embodiment of a method 800 of the present invention. Here, in Step 802, the emergency communication and propulsion system are provided as part of an eVTOL multirotor aircraft vehicle 1000 as discussed previously in regard to FIG. 1, FIG. 9, and FIG. 10. In certain embodiments, the vehicle 1000 may further be provided with auxiliary fuel tanks 22 to increase the amount of time the vehicle 1000 can stay airborne. In Step 804, the vehicle with the emergency communication system is deployed to a location requiring emergency communication, using the flight capabilities of the vehicle 1000. In certain embodiments, the vehicle 1000 may loiter or hover in the air at the location. In Step 806, the cell site subsystem is activated to provide wireless communication functionality at the location.

The systems and methodology of the present invention can be used replace or augment conventional truck or trailer based cell sites to provide wireless communication in areas where wireless communication, such as cellular networks, is unavailable, or where such communication is only needed temporarily such as in the aftermath of natural disasters affecting communication. Example uses include deployment in areas where cellular or other wireless communication has been temporarily disrupted or cannot handle the volume of communication. The present invention overcomes many of the issues with conventional terrestrial and engine-generator based systems. In many instances, the roadways required to deploy such terrestrial systems may be inaccessible or totally non-existent. In addition, such conventional terrestrial systems often use a reciprocating engine, powered by combusting fuels including gasoline (petrol), diesel, natural gas, and propane (liquid or gas) or hydrogen. This creates redundancy where the vehicle transporting the generator requires an additional engine or power generating system to propel the vehicle transporting the generator equipment to its intended destination. This redundancy consumes excess power, emits combustion exhaust inappropriate for certain applications, lowers efficiency, and increases the space required to supply mobile power.

In addition, many large cities and metropolitan areas are often gridlocked by commuter traffic, with major arteries already at or above capacity, making transport and deployment of large generating equipment increasingly impractical. The present invention overcomes these issues. Advanced technologies related to fuel cells can enable more-distributed, decentralized travel in mobile power distribution applications. Additionally, Personal Air Vehicles (PAV) or Advanced Air Mobility (AAM) vehicles, operating in an on-demand, disaggregated and scalable manner, provide short haul air mobility that could extend the effective range of mobile power delivery, but such systems rely heavily on integrated airspace, automation, and technology. Small Air Mobility Vehicles or aircraft allow for mobile communication support to move efficiently and simply from point-to-any-point, without being restricted by ground transportation congestion or the availability of high-capability airports. Added benefits include enabling operation of automated self-operated vehicles, and operation of environmentally responsible non-hydrocarbon-powered aircraft for intra-urban applications.

The methods 700/800 and systems 100 described herein are not limited to a particular vehicle 1000 or hardware or software configuration and may find applicability in many vehicles or operating environments. For example, the algorithms described herein can be implemented in hardware or software, or a combination thereof. The methods 700/800 and systems 100 can be implemented in one or more computer programs, where a computer program can be understood to include one or more processor executable instructions. The computer program(s) can execute on one or more programmable processors and can be stored on one or more storage medium readable by the processor (including volatile and non-volatile memory and/or storage elements), one or more input devices, and/or one or more output devices. The processor thus can access one or more input devices to obtain input data and can access one or more output devices to communicate output data. The input and/or output devices can include one or more of the following: a mission control tablet computer 36, mission planning software 34 program, throttle pedal, sidearm controller, yoke or control wheel, or other motion-indicating device capable of being accessed by a processor, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

As provided herein, the processor(s) can thus in some embodiments be embedded in three identical devices that can be operated independently in a networked or communicating environment, where the network can include, for example, a Local Area Network (LAN) such as Ethernet, or serial networks such as RS232 or CAN. The network(s) can be wired, wireless RF, fiber optic or broadband, or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices to perform the necessary algorithms and determine the appropriate vehicle commands, and if implemented in three units, the three units can vote among themselves to arrive at a 2 out of 3 consensus for the actions to be taken. The voting can use other system-state information to break any ties that may occur when an even number of units disagree, thus having the system arrive at a consensus that provides an acceptable level of safety for operations.

The device(s) or computer systems that integrate with the processor(s) for displaying presentations can include, for example, a personal computer with display, a workstation (e.g., Sun, HP), a personal digital assistant (PDA) or tablet such as an iPad, or another device capable of communicating with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. References to a network, unless provided otherwise, can include one or more networks, intranets and/or the internet.

Although the methods and systems have been described relative to specific embodiments thereof, they are not so limited. For example, the methods and systems may be applied to a variety of vehicles having 6, 8, 10, 12, 14, 16, or more independent motor controllers 24 and motors, thus providing differing capabilities. The system may be operated under an operator's control, or it may be operated via network or datalink from the ground. The vehicle may be operated solely with the onboard battery cell 27 storage capacity, or it may have its capacity augmented by an onboard motor-generator or other recharging source, or it may even be operated at the end of a tether or umbilical cable for the purposes of providing energy to the craft. Many modifications and variations may become apparent in light of the above teachings and many additional changes in the details, materials, and arrangement of parts, herein described and illustrated, may be made by those skilled in the art.

What is claimed is:

1. A full-scale, electric vertical takeoff and landing (eVTOL) vehicle system having a mobile emergency power communication and vehicle propulsion power system, comprising:
a multirotor airframe fuselage;
a plurality of propeller assemblies attached to the multirotor airframe fuselage;
at least one fuel cell module disposed in the fuselage, the fuel cell module comprising a plurality of hydrogen fuel cells with at least one electrical circuit configured to collect electrons from each hydrogen fuel cell of the plurality of hydrogen fuel cells and supply voltage and current;
a fuel supply subsystem comprising a fuel tank in fluid communication with the at least one fuel cell module; and
a power distribution monitoring and control subsystem disposed in the fuselage, monitoring and controlling distribution of supplied electrical voltage and current from at least one electrical circuit, the power distribution monitoring and control subsystem comprising:
one or more sensing devices configured to measure operating conditions;
a plurality of motor controllers operating the plurality of propeller assemblies; and
a cell site subsystem providing wireless communication functionality;
wherein the system selectably directs power from the at least one fuel cell module to the plurality of motor controllers to power vehicle propulsion and/or the cell site subsystem.

2. The system of claim 1, wherein the fuel supply subsystem further comprises one or more auxiliary fuel tanks.

3. The system of claim 1, wherein the cell site subsystem comprises:
a donor/reception antenna;
a rebroadcasting/service antenna; and
a bi-directional amplifier.

4. The system of claim 1, wherein the cell site subsystem comprises a cellular repeater in electronic communication with or establishing a datalink with one or more cell sites, cellular towers, or cellular base stations, wherein the cellular repeater, one or more cell sites, cellular towers, or cellular base stations are each governed by a common protocol enabling data to be transferred to and from the cellular repeater and the one or more cell sites, cellular towers, or cellular base stations.

5. The system of claim 1, wherein the selectable direction of power is controlled via a Controller Area Network (CAN) bus.

6. The system of claim 1, wherein the power distribution monitoring and control subsystem further comprises:
the one or more sensing devices configured to measure operating conditions comprising at least a temperature sensor; and
the electrical circuit configured to collect electrons from each hydrogen fuel cell of the plurality of hydrogen fuel cells and supply voltage and current to the plurality of motor controllers and vehicle components, wherein electrons returning from the electrical circuit combine with oxygen in compressed air to form oxygen ions, then protons combine with oxygen ions to form H₂O molecules, wherein the plurality of motor controllers are commanded by one or more autopilot control units or computer units comprising a computer processor configured to compute algorithms based on measured operating conditions, and configured to select and control an amount and distribution of electrical voltage or current for each of the plurality of motor controllers and/or the cell site subsystem.

7. The system of claim 1, wherein the electrical circuit comprises an electrical collector disposed within each hydrogen fuel cell and configured to collect electrons from an anode side catalyst layer and supply voltage and current to the electrical circuit powering vehicle components comprising a power distribution monitoring and control subsystem comprising the cell site subsystem, the plurality of motor controllers configured to control the plurality of propeller assemblies in the vehicle, wherein electrons returning from the electrical circuit combine with oxygen in compressed air to form oxygen ions, then protons combine with oxygen ions to form H₂O molecules.

8. The system of claim 1, wherein the power distribution monitoring and control subsystem comprises variable controls for electrical power supply that control varied power output based on user selective activation of the at least one fuel cell module up to an entire 400 kilowatt or greater on-board power generation capacity of a clean fuel aircraft.

9. The system of claim 1, further comprising:
one or more circuit boards;
one or more processors;
one or more memory;
one or more electronic components, electrical connections, electrical wires; and
one or more diode or field-effect transistors (FET, IGBT or SiC) providing isolation between an electrical main bus and one or more electrical sources comprising the at least one fuel cell module.

10. The system of claim 1, wherein the fuel cell module further comprises a module housing, a fuel delivery assembly, a recirculation pump, a coolant pump, fuel cell controls, sensors, coolant conduits transporting coolant, connections, a hydrogen inlet, a coolant inlet, an air inlet, a hydrogen outlet, an air outlet, a coolant outlet, and coolant conduits connected to and in fluid communication with the at least one fuel cell module and one or more sensing devices are configured to report temperature and operating conditions or parameters, using a Controller Area Network (CAN) bus, to one or more autopilot control units or computer units and further comprise one or more of pressure gauges, level sensors, vacuum gauges, temperature sensors, and further comprise one or more of the at least one fuel cell modules configured to self-measure or motor controllers configured to self-measure.

11. The system of claim 1, further comprising one or more autopilot control units or computer units comprising at least two redundant autopilot control units or computer units that communicate a voting process over a redundant network to command a plurality of motor controllers, the fuel supply subsystem, at least one fuel cell module, and fluid control units with commands operating valves, pumps, and combinations thereof, altering flows of fuel, air and/or coolant to different locations, thereby controlling the cell site subsystem.

12. The system of claim 1, wherein the eVTOL is sized, dimensioned, and configured for transporting one or more human occupants and/or a payload, comprising a multirotor airframe fuselage supporting vehicle weight, human occupants and/or payload, attached to and supporting a plurality of motor controllers and propeller assemblies, each comprising a plurality of pairs of rotor blades or propeller blades, and each being electrically connected to and controlled by the plurality of motor controllers and a power distribution monitoring and control subsystem distributing voltage and current from the plurality of hydrogen fuel cells.

13. The system of claim 1, further comprising a mission planning computer comprising software, with wired or wireless (RF) connections to one or more autopilot control units.

14. The system of claim 13, wherein the one or more autopilot control units comprise a computer processor and input/output interfaces comprising at least one of interface selected from serial RS232, Controller Area Network (CAN), Ethernet, analog voltage inputs, analog voltage outputs, pulse-width-modulated outputs for motor control, an embedded or stand-alone air data computer, an embedded or stand-alone inertial measurement device, and one or more cross-communication channels or networks, and a means of combining data onto a serial line, in such a way that multiple channels of command data pass to the one or more autopilot control units over the serial line, where control information is packaged in a plurality of frames that repeat at a periodic or aperiodic rate.

15. The system of claim 13, further comprising a simplified computer and display with an arrangement of standard avionics used to monitor and display operating conditions including of the cell site subsystem, control panels, gauges, and sensor output for the eVTOL.

16. The system of claim 1, further comprising a DC-DC converter or starter/alternator configured to down-shift at least a portion of a primary voltage of a multirotor aircraft system to a standard voltage comprising one or more of the group consisting of 12V, 24V, 28V, or other standard voltage for avionics, cell site subsystem, radiator fan motors, compressor motors, water pump motors and non-propulsion purposes, with a battery of corresponding voltage to provide local current storage.

17. A method of operating an integrated mobile emergency communication and vehicle propulsion power system disposed in a full-scale, electric vertical takeoff and landing (eVTOL) vehicle, comprising:
providing an eVTOL vehicle having an integrated mobile emergency communication and vehicle propulsion power system;
at least one fuel cell module of the comprising a plurality of hydrogen fuel cells with at least one electrical circuit collecting electrons from each hydrogen fuel cell of the plurality of hydrogen fuel cells and supplying voltage and current;
a fuel supply subsystem of the integrated mobile emergency communication and vehicle propulsion power system fueling the at least one fuel cell module; and
a power distribution monitoring and control subsystem of the integrated mobile emergency communication and vehicle propulsion power system distributing supplied voltage and current from at least one electrical circuit comprising:
one or more sensing devices measuring operating conditions;
a cell site subsystem providing wireless communication functionality; and
selectably directing power from the at least one fuel modules to power vehicle propulsion and/or to the cell site subsystem or both.

18. The method of claim 17, further comprising measuring and reporting operating conditions or parameters, using one or more sensing devices, and a Controller Area Network (CAN) bus to inform one or more autopilot control units or computer units, based on data from one or more of pressure gauges, level sensors, vacuum gauges, temperature sensors, the at least one fuel cell modules configured to self-measure or motor controllers configured to self-measure.

19. The method of claim 18, wherein the method repeats measuring, using one or more digital feedback measurements communicated by the cell site subsystem via the Controller Area Network (CAN) bus, operating conditions in the cell site subsystem, and then performs comparing, computing, selecting and controlling, and executing steps using data for the one or more fuel cell modules to iteratively manage electric voltage and current production and supply by the one or more fuel cell modules and operating conditions in the cell site subsystem.

20. The method of claim 18, wherein the method repeats measuring, using one or more temperature sensing devices or thermal energy sensing devices, operating conditions in a multirotor aircraft, and then performs comparing, computing, selecting and controlling, and executing steps using data for the one or more fuel cell modules to iteratively manage electric voltage and current or torque production and supply by the one or more fuel cell modules and operating conditions in the eVTOL vehicle.

21. The method of claim 18, further comprising one or more autopilot control units or computer units comprising at least two redundant autopilot control units that communicate a voting process over a redundant network to command, using one or more autopilot control units that operate control algorithms generating commands, a plurality of motor controllers, the fuel supply subsystem, the one or more fuel cell modules, and fluid control units with commands operating valves, pumps, and combinations thereof, altering flows of fuel, air and/or coolant to different locations, managing and maintaining vehicle stability and monitoring feedback.

22. A method of providing emergency communication, the method comprising:
providing an electric vertical takeoff and landing (eVTOL) vehicle having an emergency communication system comprising:
a multirotor airframe fuselage;
a plurality of propeller assemblies attached to the multirotor airframe fuselage;
at least one fuel cell module disposed in the multirotor airframe fuselage, the at least one fuel cell module comprising a plurality of hydrogen fuel cells with at least one electrical circuit configured to collect electrons from each hydrogen fuel cell of the plurality of hydrogen fuel cells and supply voltage and current;
a fuel supply subsystem comprising a fuel tank in fluid communication with the at least one fuel cell module; and
a power distribution monitoring and control subsystem monitoring and controlling distribution of supplied electrical voltage and current from at least one electrical circuit, the power distribution monitoring and control subsystem comprising:
one or more sensing devices configured to measure operating conditions; and
a cell site subsystem providing wireless communication functionality;
wherein the power distribution monitoring and control subsystem selectably directs power from the at least one fuel cell module to power the plurality of propeller assemblies and/or the cell site subsystem;
deploying the eVTOL vehicle having the emergency communications system to a location requiring emergency communication; and
activating the cell site subsystem to provide wireless communication.

23. The method of claim 22, wherein the eVTOL vehicle having been deployed to the location loiters in air at the location.

24. The method of claim 22, wherein the fuel supply subsystem of the eVTOL vehicle further comprises one or more auxiliary tanks to extend the available loiter time at the location.
